(19) United States
(12) Patent Application Publication
(10) Pub. No.: US 2023/0335129 A1
(43) Pub. Date: Oct. 19, 2023

(54) METHOD AND DEVICE FOR PROCESSING VOICE INPUT OF USER

(71) Applicant: SAMSUNG ELECTRONICS CO., LTD., Suwon-si (KR)

(72) Inventor: Heekyoung SEO, Suwon-si (KR)

(73) Assignee: SAMSUNG ELECTRONICS CO., LTD., Suwon-si (KR)

(21) Appl. No.: 18/118,502

(22) Filed: Mar. 7, 2023

Related U.S. Application Data
(63) Continuation of application No. PCT/KR2023/002481, filed on Feb. 21, 2023.

(30) Foreign Application Priority Data
Feb. 25, 2022 (KR) 10-2022-0025506

(51) Int. Cl. G10L 15/22; G10L 15/02

(52) U.S. Cl. CPC G10L 15/22; G10L 15/02; G10L 2015/027

(57) ABSTRACT

A method, performed by an electronic device, of processing a voice input of a user. The method includes obtaining a first audio signal from a first user voice input, obtaining a second audio signal from a second user voice input that is obtained subsequent to the first audio signal, identifying whether the second audio signal is an audio signal for correcting the obtained first audio signal, when the obtained second audio signal is an audio signal for correcting the obtained first audio signal, obtaining, from the obtained second audio signal, at least one of one or more corrected words or one or more corrected syllables, based on the at least one of the one or more corrected words or the one or more corrected syllables, identifying at least one corrected audio signal for the obtained first audio signal, and processing the at least one corrected audio signal.

### TECHNICAL FIELD

The disclosure relates to a method and device for processing a voice input of a user.

### BACKGROUND ART

Speech recognition is a technique for receiving an input of a voice from a user, automatically converting the voice into a text, and recognizing the text. Recently, speech recognition is used as an interfacing technique for replacing a keyboard input for a smart phone or a television (TV), and a user may input audio (e.g., an utterance) to a device and receive a response to the input audio.

However, in a case in which a voice of the user is misrecognized, the user may re-input a voice for correcting the misrecognition. Accordingly, there is a need for a technique for accurately determining whether a second voice of a user is for correcting a first voice, and providing the user with a corrected response according to the input of the second voice.

### DESCRIPTION OF EMBODIMENTS

### Technical Problem

An embodiment of the disclosure is to provide a method and device for processing a voice input of a user, based on whether an audio signal is for correcting an immediately previously input audio signal.

### Solution to Problem

According to an embodiment of the disclosure, a method may include obtaining a first audio signal from a first user voice input of the user, obtaining a second audio signal from a second user voice input of the user that is obtained subsequent to the first audio signal, identifying whether the second audio signal is an audio signal for correcting the obtained first audio signal, in response to the identifying that the obtained second audio signal is an audio signal for correcting the first audio signal, obtaining, from the second audio signal, at least one of one or more corrected words and one or more corrected syllables, based on the obtained at least one of the one or more corrected words or the one or more corrected syllables, identifying at least one corrected audio signal for the obtained first audio signal, and processing the identified at least one corrected audio signal.

According to an embodiment of the disclosure, the identifying of whether the obtained second audio signal is the audio signal for correcting the obtained first audio signal may include, based on a similarity between the obtained first audio signal and the obtained second audio signal, identifying at least one of whether the obtained second audio signal has at least one vocal characteristic and whether a voice pattern of the obtained second audio signal corresponds to at least one preset voice pattern.

According to an embodiment of the disclosure, the identifying of the obtained at least one corrected audio signal may include, based on the at least one of the one or more corrected words or the one or more corrected syllables, obtaining at least one misrecognized word included in the first audio signal, obtaining, from among at least one word included in a named entity (NE) dictionary, at least one word, a similarity of which to the one or more corrected words is greater than or equal to a preset first threshold, and identifying the at least one corrected audio signal by correcting the obtained at least one misrecognized word, to at least one of the at least one word corresponding to the obtained at least one misrecognized word, or the at least one corrected word.

According to an embodiment of the disclosure, the identifying of the at least one of whether the obtained second audio signal has the at least one vocal characteristic, or whether the voice pattern of the obtained second audio signal corresponds to the at least one preset voice pattern may include, when the obtained similarity is greater than or equal to a preset second threshold, identifying whether the obtained second audio signal has the at least one vocal characteristic, and when the obtained similarity is less than the preset second threshold, identifying whether the voice pattern of the obtained second audio signal corresponds to the at least one preset voice pattern.

According to an embodiment of the disclosure, the identifying of whether the obtained second audio signal has the at least one vocal characteristic may include obtaining second pronunciation information for each of at least one syllable included in the obtained second audio signal, and based on the second pronunciation information, identifying whether the at least one syllable included in the obtained second audio signal has the at least one vocal characteristic.

According to an embodiment of the disclosure, the identifying of whether the obtained second audio signal has the at least one vocal characteristic may include, when the at least one syllable included in the obtained second audio signal has the at least one vocal characteristic, obtaining first pronunciation information for each of at least one syllable included in the obtained first audio signal, obtaining a score for a voice change in the at least one syllable included in the obtained second audio signal, by comparing the first pronunciation information with the second pronunciation information, and identifying at least one syllable, the obtained score of which is greater than or equal to a preset third threshold, and identifying, as the one or more corrected syllables and the one or more corrected words, the identified at least one syllable and at least one word corresponding to the identified at least one syllable, respectively.

According to an embodiment of the disclosure, the first pronunciation information may include at least one of accent information, amplitude information, or duration information for each of the at least one syllable included in the obtained first audio signal, and the second pronunciation information may include at least one of accent information, amplitude information, or duration information for each of the at least one syllable included in the obtained second audio signal.

According to an embodiment of the disclosure, the identifying of whether the voice pattern of the obtained second audio signal corresponds to the at least one preset voice pattern may include, based on an NLP model, identifying that the voice pattern of the obtained second audio signal corresponds to the at least one preset voice pattern, and the obtaining of the at least one of the one or more corrected words or the one or more corrected syllables may include, based on the voice pattern of the second audio signal, obtaining the at least one of the one or more corrected words or the one or more corrected syllables, by using the NLP model.

According to an embodiment of the disclosure, the identifying of the at least one corrected audio signal may include identifying, by using the NLP model, whether the voice pattern of the obtained second audio signal is a complete voice pattern among the at least one preset voice pattern, based on the voice pattern of the obtained second audio signal being identified as the complete voice pattern, obtaining at least one of one or more misrecognized words or one or more misrecognized syllables included in the obtained first audio signal, and identifying the at least one corrected audio signal by correcting the obtained at least one of the one or more misrecognized words or the one or more misrecognized syllables, to the at least one of the one or more corrected words or the one or more corrected syllables corresponding thereto, and the complete voice pattern may be a voice pattern including at least one of one or more misrecognized words or one or more misrecognized syllables of an audio signal, and at least one of one or more corrected words or one or more corrected syllables, among the at least one preset voice pattern.

According to an embodiment of the disclosure, the identifying of the at least one corrected audio signal may include, based on the at least one of the at least one corrected word or the at least one corrected syllable, obtaining at least one of at least one misrecognized word or at least one misrecognized syllable included in the obtained first audio signal, and based on the at least one of the at least one corrected word and the at least one corrected syllable, and the at least one of the one or more misrecognized words or the one or more misrecognized syllables included in the obtained first audio signal, identifying the at least one corrected audio signal.

According to an embodiment of the disclosure, the processing of the at least one corrected audio signal may include receiving, from the user, a response signal related to misrecognition, as search information for the at least one corrected audio signal is output to the user, and requesting the user to perform reutterance according to the response signal.

According to an embodiment of the disclosure, an electronic device for processing a voice input of a user, the electronic device may include a memory storing one or more instructions, and at least one processor configured to execute the one or more instructions to obtain a first audio signal from a first user voice input of the user, obtain a second audio signal from a second user voice input of the user that is obtained subsequent to the first audio signal, identify whether the second audio signal is an audio signal for correcting the first audio signal, in response to the determining that the obtained second audio signal is an audio signal for correcting the obtained first audio signal, obtain, from the obtained second audio signal, at least one of one or more corrected words or one or more corrected syllables, based on the at least one of the one or more corrected words or the one or more corrected syllables, identify at least one corrected audio signal for the obtained first audio signal, and process the at least one corrected audio signal.

According to an embodiment of the disclosure, a non-transitory computer-readable recording medium having recorded thereon instructions for causing a processor of an electronic device to perform the method may be provided.

### Advantageous Effects of Disclosure

According to an embodiment of the disclosure, an electronic device may identify, based on whether an audio signal is for correcting an immediately previously input audio signal, a corrected audio signal, and provide a user with a response according to the corrected audio signal, considering the intention of correction. Thus, the electronic device may determine whether the audio signal is for correcting the immediately previously input audio signal, and thus provide an appropriate response according to the audio signal, considering the intention of the user.

### BRIEF DESCRIPTION OF DRAWINGS

FIG. 1 is a diagram illustrating a method of processing a voice input of a user, according to an embodiment of the disclosure.

FIG. 2 is a block diagram illustrating an electronic device for processing a voice input of a user, according to an embodiment of the disclosure.

FIG. 3 is a block diagram illustrating an electronic device for processing a voice input of a user, according to an embodiment of the disclosure.

FIG. 4 is a flowchart for processing a voice input of a user, according to an embodiment of the disclosure.

FIG. 5 is a diagram illustrating in detail a method of processing a voice input of a user, according to an embodiment of the disclosure.

FIG. 6 is a diagram illustrating in detail a method, which is subsequent to the method of FIG. 5, of processing a voice input of a user, according to an embodiment of the disclosure.

FIG. 7 is a flowchart illustrating in detail a method of identifying, based on the similarity between a first audio signal and a second audio signal, at least one of whether the second audio signal has at least one vocal characteristic or whether a voice pattern of the second audio signal corresponds to at least one preset voice pattern, according to an embodiment of the disclosure.

FIG. 8 is a flowchart illustrating in detail a method of, in a case in which a first audio signal and a second audio signal are similar to each other, identifying at least one corrected audio signal for the first audio signal according to whether at least one syllable included in the second audio signal has at least one vocal characteristic, according to an embodiment of the disclosure.

FIG. 9 is a diagram illustrating a detailed method of identifying at least one corrected audio signal according to whether at least one syllable included in a second audio signal includes at least one vocal characteristic.

FIG. 10 is a diagram illustrating a detailed method, which is subsequent to the method of FIG. 9, of identifying at least one corrected audio signal according to whether at least one syllable included in a second audio signal includes at least one vocal characteristic.

FIG. 11 is a diagram illustrating a detailed embodiment of the disclosure of identifying at least one corrected audio signal according to whether at least one syllable included in a second audio signal has at least one vocal characteristic, according to an embodiment of the disclosure.

FIG. 12 is a flowchart illustrating in detail a method of, in a case in which a first audio signal and a second audio signal are not similar to each other, identifying at least one corrected audio signal for the first audio signal according to whether a voice pattern of the second audio signal corresponds to at least one preset voice pattern.

FIG. 13 is a flowchart illustrating in detail a method of identifying at least one corrected audio signal for a first audio signal, according to whether a voice pattern of a second audio signal corresponds to at least one preset voice pattern.

FIG. 14 is a diagram illustrating a detailed method of identifying at least one corrected audio signal for a first audio signal according to whether a voice pattern of a second audio signal corresponds to at least one preset voice pattern, according to an embodiment of the disclosure.

FIG. 15 is a diagram illustrating a detailed method, which is subsequent to the method of FIG. 14, of identifying at least one corrected audio signal for a first audio signal according to whether a voice pattern of a second audio signal corresponds to at least one preset voice pattern, according to an embodiment of the disclosure.

FIG. 16 is a diagram illustrating a detailed method of identifying at least one corrected audio signal for a first audio signal according to whether a voice pattern of a second audio signal corresponds to at least one preset voice pattern, according to an embodiment of the disclosure.

FIG. 17 is a diagram illustrating a detailed method of identifying at least one corrected audio signal for a first audio signal according to whether a voice pattern of a second audio signal corresponds to at least one preset voice pattern, according to an embodiment of the disclosure.

FIG. 18 is a diagram illustrating a detailed method, which is subsequent to the method of FIG. 17, of identifying at least one corrected audio signal for a first audio signal according to whether a voice pattern of a second audio signal corresponds to at least one preset voice pattern, according to an embodiment of the disclosure.

FIG. 19 is a diagram illustrating a detailed embodiment of the disclosure of identifying at least one corrected audio signal for a first audio signal according to whether a voice pattern of a second audio signal corresponds to at least one preset voice pattern, according to an embodiment of the disclosure.

FIG. 20 is a flowchart illustrating in detail a method of identifying at least one corrected audio signal by obtaining, from among at least one word included in a named entity dictionary, at least one word similar to at least one corrected word.

### MODE OF DISCLOSURE

Throughout the disclosure, the expression “at least one of a, b, or c” indicates only a, only b, only c, both a and b, both a and c, both b and c, all of a, b, and c, or variations thereof.

The terms used herein will be briefly described, and then an embodiment of the disclosure will be described in detail.

Although the terms used herein are selected from among common terms that are currently widely used in consideration of their functions in an embodiment of the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding description of an embodiment of the disclosure. Therefore, the terms used herein are not merely designations of the terms, but the terms are defined based on the meaning of the terms and content throughout the disclosure.

Throughout the specification, when a part “includes” a component, it means that the part may additionally include other components rather than excluding other components as long as there is no particular opposing recitation. Furthermore, as used herein, the term “unit” denotes a hardware element such as a field-programmable gate array (FPGA) or an application-specific integrated circuit (ASIC), and such “units” perform certain functions. However, the term “unit” is not limited to software or hardware. The “unit” may be configured either to be stored in an addressable storage medium or to execute one or more processors. Thus, for example, the “unit” may include elements such as software elements, object-oriented software elements, class elements and task elements, processes, functions, attributes, procedures, subroutines, segments of program code, drivers, firmware, micro-code, circuits, data, a database, data structures, tables, arrays, or variables. Functions provided by the elements and “units” may be combined into the smaller number of elements and “units”, or may be divided into additional elements and “units”.

Hereinafter, an embodiment of the disclosure is described in detail with reference to the accompanying drawings to allow those of skill in the art to easily carry out the embodiment of the disclosure. An embodiment of the disclosure may, however, be embodied in many different forms and should not be construed as being limited to the embodiments of the disclosure set forth herein. Also, parts in the drawings unrelated to the detailed description are omitted to ensure clarity of the disclosure, and like reference numerals in the drawings denote like elements.

Throughout the specification, when a part is referred to as being “connected to” another part, it may be “directly connected to” the other part or be “electrically connected to” the other part through an intervening element. In addition, when an element is referred to as “including” a component, the element may additionally include other components rather than excluding other components as long as there is no particular opposing recitation.

In the disclosure, in a case in which a second audio signal is for correcting a first audio signal, a corrected word and a corrected syllable may refer to a post-correction word and a post-correction syllable included in the second audio signal, respectively.

In the disclosure, in a case in which a second audio signal is for correcting a first audio signal, a misrecognized word and a misrecognized syllable may refer to a word to be corrected and a syllable to be corrected, which are included in the first audio signal, respectively.

In the disclosure, a vocal characteristic may refer to a syllable or a letter having a characteristic in pronunciation, among at least one syllable included in a received audio signal. In detail, an electronic device may identify, based on pronunciation information for at least one syllable included in an audio signal, whether at least one vocal characteristic is present in the at least one syllable included in the audio signal.

In the disclosure, a preset voice pattern may refer to a preset voice pattern for an audio signal of an utterance with an intention of correcting a misrecognized audio signal. In detail, a natural language processing model may be trained by using, as training data, misrecognized audio signals and audio signals of utterances with intentions of correcting the misrecognized audio signals, and the electronic device may obtain preset voice patterns through the natural language processing model.

In the disclosure, a complete voice pattern may refer to a voice pattern including both 1) a post-correction word and a post-correction syllable and 2) a pre-correction word and a pre-correction syllable, among the preset voice patterns.

In the disclosure, a ‘trigger word’ may refer to a word that is a criterion for determining initiation of speech recognition by the electronic device. Based on the similarity between the trigger word and an utterance of the user, it may be determined whether the trigger word is included in the utterance of the user. In detail, based on an acoustic model that is trained based on acoustic information, the electronic device or a server may determine the similarity between the trigger word and the utterance of the user, based on probability information about the degree to which the utterance of the user and the acoustic model match with each other. The trigger word may include at least one preset trigger word. The trigger word may be a wake-up word or a speech recognition start instruction. In the specification, the wake-up word or the speech recognition start instruction may be referred to as a trigger word.

Hereinafter, the disclosure will be described in detail with reference to the accompanying drawings.

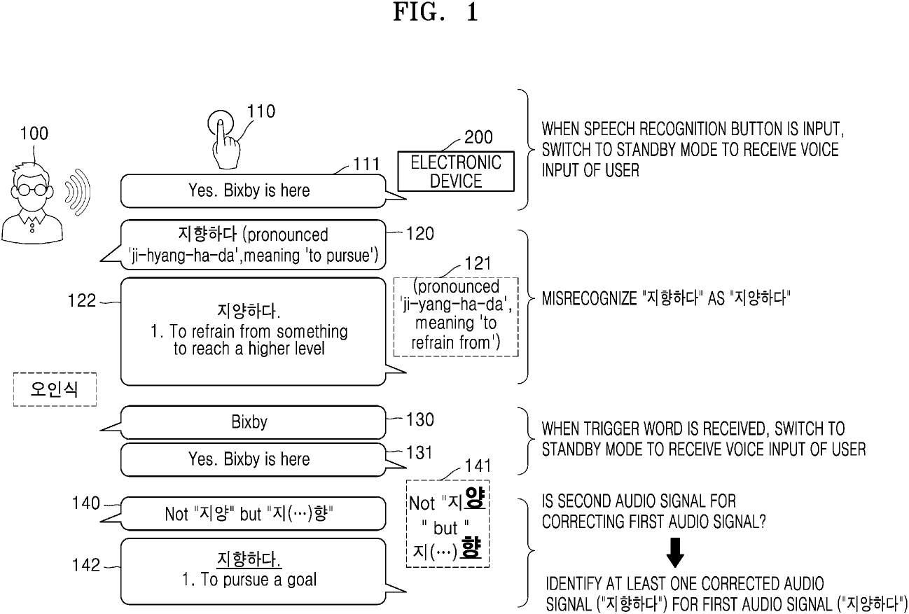

FIG. 1 is a diagram illustrating a method of processing a voice input of a user, according to an embodiment of the disclosure.

Referring to FIG. 1, an electronic device 200 according to an embodiment of the disclosure may recognize an audio signal according to a voice input (e.g., an utterance) of a user 100, process the recognized audio signal, and thus provide the user 100 with a response. In the specification, the voice input may refer to a voice or an utterance of the user, and the audio signal may refer to a signal recognized as the electronic device receives the voice input of the user.

Speech recognition according to an embodiment of the disclosure may be initiated when the user 100 presses an input button related to voice input or utters one of at least one preset trigger word for the electronic device 200, and accordingly, the speech recognition by the electronic device may be executed. For example, the user 100 may input a speech recognition execution command by pressing a button for executing the speech recognition by the electronic device 200 (110), and accordingly, the electronic device 200 may be switched to a standby mode for receiving a command-related utterance of the user 100.

As the electronic device 200 according to an embodiment of the disclosure is switched to the standby mode, the electronic device 200 may output an audio signal or a user interface (UI) for requesting a command-related utterance from the user 100. For example, the electronic device 200 may request the user 100 to input a command-related utterance by outputting an audio signal, saying “Yes. Bixby is here” 111.

The user 100 may input an utterance for a command related to speech recognition. For example, a voice input that is input by the user 100 may be an utterance related to search. In detail, the user 100 may input a first user voice input [symbol] 120 (pronounced ‘ji-hyang-ha-da’ in Korean, meaning ‘to pursue’) in order to search for the meaning of the word [symbol] 120.

The electronic device 200 according to an embodiment of the disclosure may receive the first user voice input [symbol] 120, and obtain a first audio signal from the received first user voice input. For example, the electronic device 200 may obtain a first audio signal [symbol] 121 (pronounced ‘ji-yang-ha-da’, meaning ‘to refrain from’), which is pronounced similarly to [symbol] 120, and thus, the electronic device 200 may misrecognize [symbol] as [symbol] . In addition, the electronic device 200 may provide the user 100 with search information 122 about [symbol] 121, which is the misrecognized first audio signal.

The electronic device 200 according to an embodiment of the disclosure may receive “Bixby” 130, which is one of at least one preset trigger word, before receiving a second user voice input from the user 100. In response to an utterance of the user 100, saying “Bixby” 130, a speech recognition function of the electronic device may be reexecuted. For example, the electronic device 200 may be switched to the standby mode for receiving a command-related utterance of the user 100. However, when the user 100 inputs a second user voice input 140 within a preset period after inputting the first user voice input, the speech recognition may be executed without requiring to utter a separate trigger word, but the disclosure is not limited thereto.

In response to “Yes. Bixby is here” 131, the user 100 may input the second user voice input “Not [symbol] but [symbol] 140. The electronic device 200 may receive the second user voice input “Not [symbol] but [symbol] 140, and obtain a second audio signal “Not [symbol] but 141. In the specification, the symbol “(...)” in relation to an utterance of the user may be a symbol indicating that the syllable pronounced before “(...)” is pronounced long. In addition, syllables marked in bold in the drawing in relation to an utterance of the user may refer to more strongly pronounced syllables compared to other syllables. Therefore, referring to FIG. 1, the electronic device 200 may recognize the second audio signal “Not [symbol] but [symbol] 141, and determine that the user 100 has emphasized

[symbol]

The electronic device 200 according to an embodiment of the disclosure may identify whether the second audio signal is for correcting the first audio signal. In detail, based on whether the second audio signal “Not [symbol] but [symbol] 141 corresponds to at least one preset voice pattern, the electronic device 200 may identify whether the second audio signal is for correcting the first audio signal. For example, by using a natural language processing model, the electronic device 200 may determine that “Not [symbol] but [symbol] 141 corresponds to a complete voice pattern among at least one preset voice pattern stored in a memory. In addition, the electronic device 200 may identify, as a vocal characteristic, the strongly pronounced [symbol] in [symbol] of “Not [symbol] but [symbol] The electronic device 200 according to an embodiment of the disclosure may identify a voice pattern of the second audio signal by using the natural language processing model, and thus determine that, in the second audio signal “Not [symbol] but [symbol] 141, [symbol] corresponds to a post-correction word, and [symbol] corresponds to a pre-correction word. In addition, because [symbol] included in the second audio signal corresponds to [symbol] of the first audio signal [symbol] 121, the electronic device 200 may obtain or identify, as at least one misrecognized word, [symbol] included in the first audio signal. The electronic device 200 according to an embodiment of the disclosure may correct the misrecognized word [symbol] to the corrected word [symbol] and thus obtain [symbol] which is a corrected audio signal for [symbol] 121, which is the first audio signal. In addition, the electronic device 200 may process [symbol] which is the corrected audio signal. For example, the electronic device 200 may provide appropriate information to the user by outputting search information 142 for

[symbol]

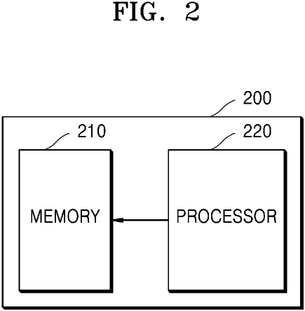

FIG. 2 is a block diagram illustrating the electronic device 200 for processing a voice input of a user, according to an embodiment of the disclosure.

The electronic device 200 according to an embodiment of the disclosure is an electronic device capable of performing speech recognition on an audio signal, and specifically, may be an electronic device for processing a voice input of a user. The electronic device 200 according to an embodiment of the disclosure may include a memory 210 and a processor 220. Hereinafter, each of the components will be described.

The memory 210 may store programs the processor 220 to perform processing and control. The memory 210 according to an embodiment of the disclosure may store one or more instructions.

The processor 220 may control the overall operation of the electronic device 200, and may control the operation of the electronic device 200 by executing the one or more instructions stored in the memory 210.

The processor 220 according to an embodiment of the disclosure may execute the one or more instructions stored in the memory to obtain a first audio signal from a first user voice input, obtain a second audio signal from a second user voice input that is subsequent to the first audio signal, based on the second audio signal being for correcting the first audio signal, obtain, from the second audio signal, at least one of at least one corrected word or at least one corrected syllable, based on the at least one of the at least one corrected word or the at least one corrected syllable, identify at least one corrected audio signal for the first audio signal, and process the at least one corrected audio signal.

The processor 220 according to an embodiment of the disclosure may execute the one or more instructions stored in the memory to identify, based on the similarity between the first audio signal and the second audio signal, at least one of whether the second audio signal has at least one vocal characteristic or whether a voice pattern of the second audio signal corresponds to at least one preset voice pattern.

The processor 220 according to an embodiment of the disclosure may execute the one or more instructions stored in the memory to obtain, based on the at least one of the at least one corrected word or the at least one corrected syllable, at least one misrecognized word included in the first audio signal, obtain, from among at least one word included in a named entity (NE) dictionary, at least one word, the similarity of which to the at least one corrected word is greater than or equal to a preset first threshold, and identify the at least one corrected audio signal by correcting the obtained at least one misrecognized word to one of at least one word corresponding thereto and the at least one corrected word.

The processor 220 according to an embodiment of the disclosure may execute the one or more instructions stored in the memory to, based on the similarity being greater than or equal to a preset second threshold, identify whether the second audio signal has at least one vocal characteristic, and based on the similarity being less than the preset second threshold, identify whether the voice pattern of the second audio signal corresponds to the at least one preset voice pattern.

The processor 220 according to an embodiment of the disclosure may execute the one or more instructions stored in the memory to obtain second pronunciation information for each of at least one syllable included in the second audio signal, and identify, based on the second pronunciation information, whether the at least one syllable included in the second audio signal has at least one vocal characteristic.

The processor 220 according to an embodiment of the disclosure may execute the one or more instructions stored in the memory to, based on the at least one syllable included in the second audio signal having the at least one vocal characteristic, obtain first pronunciation information for each of at least one syllable included in the first audio signal, obtain a score for a voice change in the at least one syllable included in the second audio signal by comparing the first pronunciation information with the second pronunciation information, identify at least one syllable, the score of which is greater than or equal to a preset third threshold, and identify, as at least one corrected syllable and at least one corrected word, the identified at least one syllable and at least one word corresponding to the identified at least one syllable, respectively.

The processor 220 according to an embodiment of the disclosure may execute the one or more instructions stored in the memory to identify, based on a natural language processing model stored in the memory, that the voice pattern of the second audio signal corresponds to the at least one preset voice pattern, and obtain, based on the voice pattern of the second audio signal, the at least one of the at least one corrected word or the at least one corrected syllable, by using the natural language processing model.

The processor 220 according to an embodiment of the disclosure may execute the one or more instructions stored in the memory to obtain, based on the at least one of the at least one corrected word or the at least one corrected syllable, at least one of at least one misrecognized word or at least one misrecognized syllable included in the first audio signal, and identify the at least one corrected audio signal, based on the at least one of the at least one corrected word or the at least one corrected syllable, and the at least one of the at least one misrecognized word or the at least one misrecognized syllable included in the first audio signal.

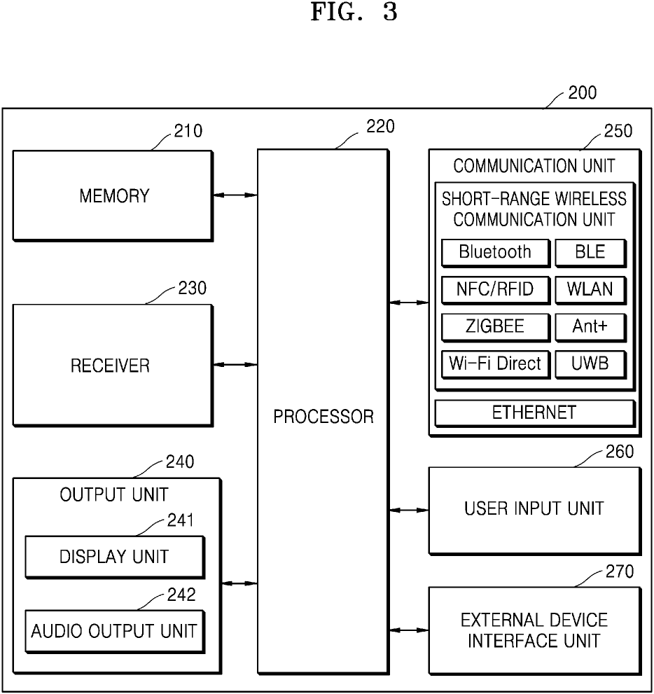

However, all of the illustrated components are not essential components. The electronic device 200 may be implemented by more components than the illustrated components, or may be implemented by fewer components than the illustrated components. For example, as illustrated in FIG. 3, the electronic device 200 according to an embodiment of the disclosure may include the memory 210, the processor 220, a receiver 230, an output unit 240, a communication unit 250, a user input unit 260, and an external device interface unit 270.

FIG. 3 is a block diagram illustrating the electronic device 200 for processing a voice input of a user, according to an embodiment of the disclosure.

The electronic device 200 according to an embodiment of the disclosure is an electronic device capable of performing speech recognition on an audio signal, and may be an electronic device for processing a voice input of a user. The electronic device may include various types of devices usable by the user, such as mobile phones, tablet personal computers (PCs), personal digital assistants (PDAs), MP3 players, kiosks, electronic picture frames, navigation devices, digital televisions (TVs), or wearable devices such as wrist watches or head-mounted displays (HMDs). In addition, the electronic device 200 may further include the receiver 230, the output unit 240, the communication unit 250, the user input unit 260, the external device interface unit 270, and a power supply unit (not shown), in addition to the memory 210 and the processor 220. Hereinafter, each of the components will be described.

The memory 210 may store programs the processor 220 to perform processing and control. The memory 210 according to an embodiment of the disclosure may store one or more instructions. The memory 210 may include at least one of an internal memory (not shown) or an external memory (not shown). The memory 210 may store various programs and data used for the operation of the electronic device 200. For example, the memory 210 may store at least one preset trigger word, and may store an engine for recognizing an audio signal. In addition, the memory 210 may store an artificial intelligence (AI) model for determining the similarity between a first user voice input of the user and a second user voice input of the user, and may store a natural language processing model used to recognize an intention of the user to correct, and at least one preset voice pattern. In particular, the first audio signal and the second audio signal may be used as training data for the natural language processing model to recognize an intention of the user for correction, but are not limited thereto. The engine for recognizing an audio signal, the AI model, the natural language processing model, and the at least one preset voice pattern may be stored in the memory 210 as well as a server for processing an audio signal, but are not limited thereto.

The internal memory may include, for example, at least one of a volatile memory (e.g., dynamic random-access memory (DRAM), static RAM (SRAM), synchronous DRAM (SDRAM), etc.), a non-volatile memory (e.g., one-time programmable read-only memory (OTPROM), programmable ROM (PROM), erasable programmable ROM (EPROM), electrically erasable programmable ROM (EEPROM), mask ROM, flash ROM, etc.), a hard disk drive (HDD), or solid-state drive (SSD). According to an embodiment of the disclosure, the processor 220 may load a command or data received from at least one of the non-volatile memory or other components into a volatile memory, and process the command or data. Also, the processor 220 may store, in the non-volatile memory, data received from other components or generated by the processor 220.

The external memory may include, for example, at least one of CompactFlash (CF), Secure Digital (SD), Micro-SD, Mini-SD, extreme Digital (xD), or Memory Stick.

The processor 220 may control the overall operation of the electronic device 200, and may control the operation of the electronic device 200 by executing the one or more instructions stored in the memory 210. For example, the processor 220 may execute the programs stored in the memory 210 to control the overall operation of the memory 210, the receiver 230, the output unit 240, the communication unit 250, the user input unit 260, the external device interface unit 270 and the power supply unit (not shown).

The processor 220 may include at least one of RAM, ROM, a central processing unit (CPU), a graphics processing unit (GPU), or a bus. The RAM, the ROM, the CPU, and the GPU, etc. may be connected to each other through the bus. According to an embodiment of the disclosure, the processor 220 may include an AI processor for generating a learning network model, but is not limited thereto. According to an embodiment of the disclosure, the AI processor may be implemented as a chip separate from the processor 220. According to an embodiment of the disclosure, the AI processor may be a general-purpose chip.

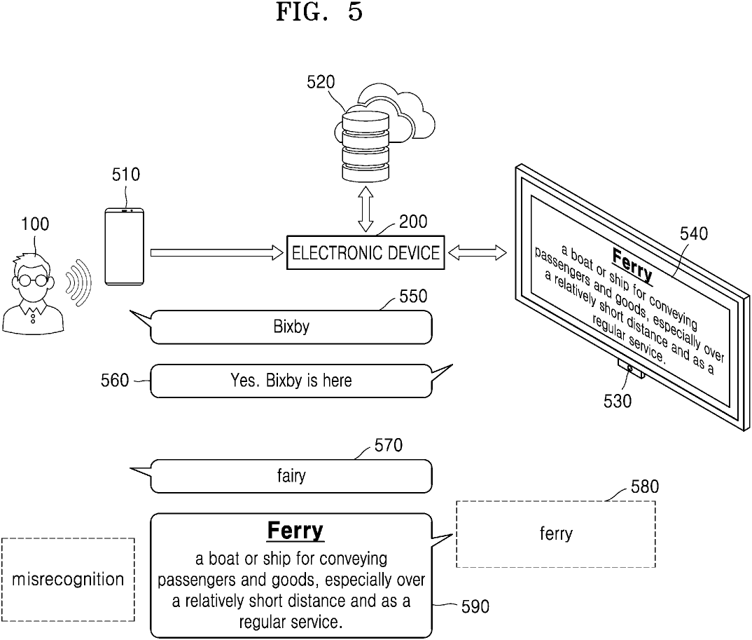

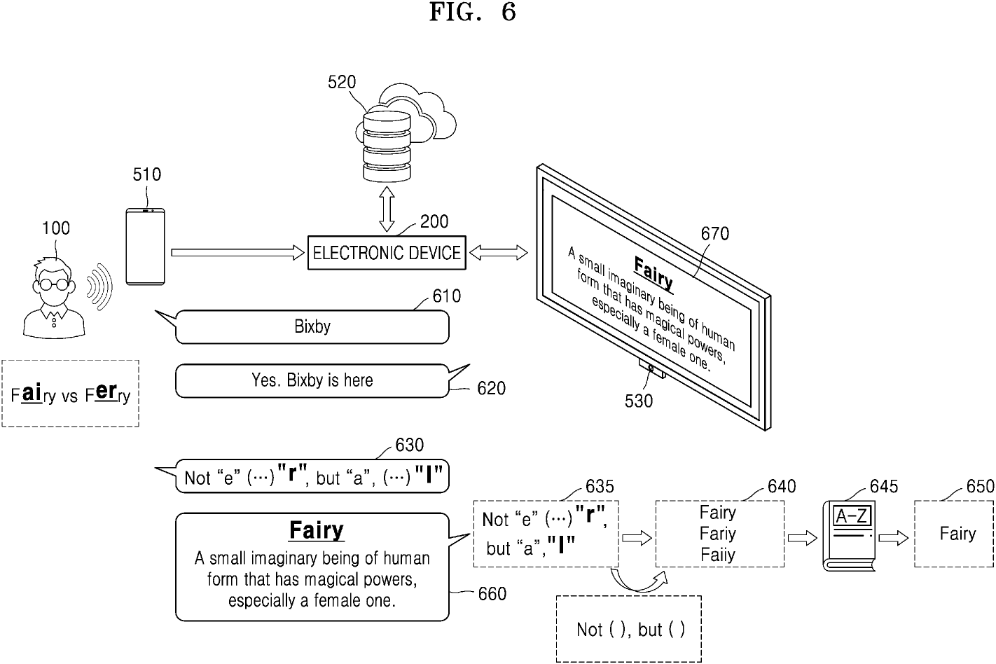

The processor 220 according to an embodiment of the disclosure may obtain a first audio signal from a first user voice input, obtain a second audio signal from a second user voice input that is subsequent to the first audio signal, based on the second audio signal being for correcting the first audio signal, obtain, from the second audio signal, at least one of at least one corrected word or at least one corrected syllable, based on the at least one of the at least one corrected word or the at least one corrected syllable, identify at least one corrected audio signal for the first audio signal, and process the at least one corrected audio signal. However, each operation performed by the processor 220 may be performed by a separate server (not shown). For example, the server may identify whether the second audio signal is for correcting the first audio signal, and transmit, to the electronic device 200, a result of the identifying, and the electronic device 200 may obtain, from the second audio signal, at least one of at least one corrected word or at least one corrected syllable. Operations between the electronic device 200 and the server will be described in detail with reference to FIGS. 5 and 6.

The receiver 230 may include a microphone built in or external to the electronic device 200, and may include one or more microphones. In detail, the processor 220 may control the receiver 230 to receive an analog voice (e.g., an utterance) of the user. Also, the processor 220 may determine whether the utterance of the user input through the receiver 230 is similar to at least one trigger word stored in the memory 210. The analog voice received by the electronic device 200 through the receiver 230 may be digitized and then transmitted to the processor 220 of the electronic device 200.

The audio signal may be a signal received and recognized through a separate external electronic device including a microphone or a portable terminal including a microphone. In this case, the electronic device 200 may not include the receiver 230. In detail, an analog voice received through the external electronic device or the portable terminal may be digitized and then received by the electronic device 200 through data transmission communication, such as Bluetooth or Wi-Fi, but is not limited thereto. Details of the receiver 230 will be described in detail with reference to FIG. 5.

A display unit 241 may include a display panel and a controller (not shown) configured to control the display panel, and may refer to a display built in the electronic device 200. The display panel may be implemented with various types of displays, such as a liquid-crystal display (LCD), an organic light-emitting diode (OLED) display, an active-matrix OLED (AMOLED) display, or a plasma display panel (PDP). The display panel may be implemented to be flexible, transparent, or wearable. The display unit 241 may be combined with a touch panel of the user input unit 260 to be provided as a touch screen. For example, the touch screen may include an integrated module in which a display panel and a touch panel are coupled to each other in a stack structure.

The display unit 241 according to some embodiments of the disclosure may output a UI related to execution of a speech recognition function corresponding to a voice of the user, under control by the processor 220. However, the electronic device 200 may output, through a display unit of the external electronic device, a UI related to execution of a function according to speech recognition in response to a voice of the user, through video and audio output ports. The display unit 241 may be included in the electronic device 200, but is not limited thereto. In addition, the display unit 241 may refer to a simple display unit 241 for displaying a notification or the like.

An audio output unit 242 may be an output unit including at least one speaker. The processor 220 according to some embodiments of the disclosure may output, through the audio output unit 242, an audio signal related to execution of the speech recognition function corresponding to a voice of the user. For example, as illustrated in FIG. 1, the electronic device 200 may output [symbol] To pursue a goal.” in the form of an audio signal. In addition, the processor 220 may output, through the audio output unit 242, an audio signal corresponding to an utterance of the user for a trigger word. For example, as illustrated in FIG. 1, the electronic device 200 may output “Yes. Bixby is here” 131 as an audio signal, in response to the user uttering a wake-up word.

The communication unit 250 may include one or more components that enable communication between the electronic device 200 and a plurality of devices around the electronic device 200. The communication unit 250 may include one or more components that enable communication between the electronic device 200 and a server. In detail, the communication unit 250 may perform communication with various types of external devices or servers according to various types of communication schemes. Also, the communication unit 250 may include a short-range wireless communication unit.

A short-range wireless communication unit includes a Bluetooth communication unit, a Bluetooth Low Energy (BLE) communication unit, a near-field Communication unit, a wireless local area network (WLAN) (e.g., Wi-Fi) communication unit, a Zigbee communication unit, and an Infrared Data Association (IrDA) communication unit, a Wi-Fi Direct (WFD) communication unit, an ultra wideband (UWB) communication unit, an Ant+ communication unit, an Ethernet communication unit, etc., but is not limited thereto.

In detail, in a case in which each operation performed by the processor 220 is performed by a server (not shown), the electronic device 200 may be connected to the server through a Wi-Fi module or an Ethernet module of the communication unit 250, but is limited thereto. In this case, the server may be a cloud-based server. In addition, the electronic device 200 may be connected to an external electronic device that receives an audio signal, through the Bluetooth communication unit or the Wi-Fi communication unit of the communication unit 250, but is not limited thereto. For example, the electronic device 200 may be connected to an external electronic device that receives an audio signal, through at least one of the Wi-Fi module or the Ethernet module of the communication unit 250.

The user input unit 260 may refer to a unit for receiving various instructions from the user, and receiving an input of data from the user to control the electronic device 200. The user input unit 260 may include, but is not limited to, at least one of a key pad, a dome switch, a touch pad (e.g., a touch-type capacitive touch pad, a pressure-type resistive overlay touch pad, an infrared sensor-type touch pad, a surface acoustic wave conduction touch pad, an integration-type tension measurement touch pad, a piezoelectric effect-type touch pad), a jog wheel, or a jog switch. The keys may include various types of keys, such as mechanical buttons or wheels formed in various areas such as the front, side, and rear surfaces of the body of the electronic device 200. The touch panel may detect a touch input of the user, and output a touch event value corresponding to a detected touch signal. In a case in which a touch screen (not shown) is configured by combining the touch panel with a display panel, the touch screen may be implemented with various types of touch sensors, such as a capacitive-type, resistive-type, or piezoelectric-type sensor. The threshold according to an embodiment of the disclosure may be adaptively adjusted through the user input unit 260, but is not limited thereto.

The external device interface unit 270 provides an interface environment between the electronic device 200 and various external devices. The external device interface unit 270 may include an audio/video (A/V) input/output unit. The external device interface unit 270 may be connected to external devices such as digital versatile disk (DVD) and Blu-ray players, game devices, cameras, computers, air conditioners, notebooks, desktops, TVs, or digital display devices, in a wired or wireless manner. The external device interface unit 270 may transmit, to the processor 220 of the electronic device 200, image, video, and audio signals input through an external device connected thereto. The processor 220 may control data signals, such as processed two-dimensional (2D) images, three-dimensional (3D) images, video, or audio, to be output to the connected external device. The A/V input/output unit may include a Universal Serial Bus (USB) port, a color, video, blanking and sync (CVBS) port, a component port, a separate video (S-video) port (analog), a Digital Visual Interface (DVI) port, a High-Definition Multimedia Interface (HDMI) port, a DisplayPort (DP) port, a Thunderbolt port, a red, green, and blue (RGB) port, a D-SUB port, etc., such that video and audio signals of an external device may be input to the electronic device 200. The processor 220 according to an embodiment of the disclosure may be connected to an external electronic device that receives an audio signal, through an interface such as the HDMI port of the external device interface unit 270. The processor 220 according to an embodiment of the disclosure may be connected, through at least one of interfaces such as the HDMI port, the DP port, or the Thunderbolt port of the external device interface unit 270, to an external electronic device (which may be a display device) that outputs, to the user, a UI related to at least one corrected audio signal, but is not limited thereto. Here, the UI related to the at least one corrected audio signal may be a UI showing a result of searching for the at least one corrected audio signal.

The electronic device 200 may further include a power supply unit (not shown). The power supply unit (not shown) may supply power to the components of the electronic device 200 under control by the processor 220. The power supply unit (not shown) may supply power input from an external power source, to each component of the electronic device 200 through a power cord under control by the processor 220.

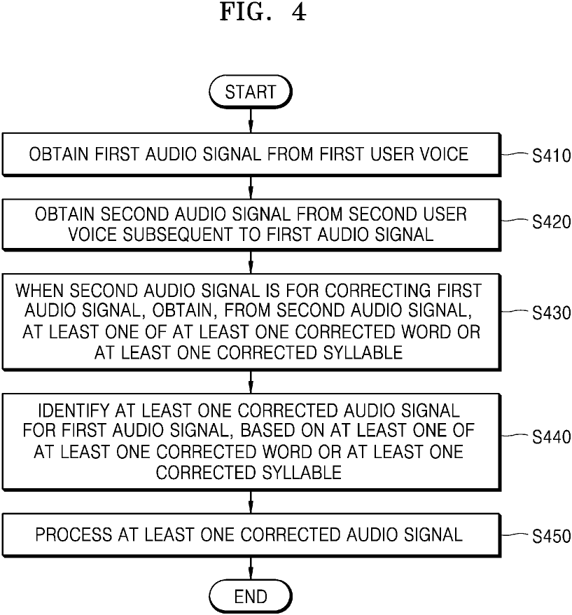

FIG. 4 is a flowchart for processing a voice input of a user, according to an embodiment of the disclosure.

In operation S410, the electronic device according to an embodiment of the disclosure may obtain a first audio signal from a first user voice input.

Referring to FIG. 1, before receiving the first user voice input, the electronic device 200 may operate in a standby mode for receiving an utterance or voice input, in response to reception of an input related to initiation of a speech recognition function. In addition, in response to reception of an input related to initiation of the speech recognition function, the electronic device 200 may request the user to utter a command-related voice input.

The electronic device 200 according to an embodiment of the disclosure may receive the first user voice input through the receiver 230 of the electronic device 200. In detail, the electronic device 200 may receive the first user voice input through the microphone of the receiver 230.

The electronic device 200 according to an embodiment of the disclosure may be an electronic device that does not include the receiver 230, and in this case, the electronic device 200 may receive a voice of the user through an external electronic device or a portable terminal including a microphone. In detail, the user may input an utterance to a microphone attached to the external electronic device, and the input utterance may be transmitted to the communication unit 250 of the electronic device 200, in the form of a digital audio signal. In addition, for example, the user may input a voice through an app of the portable terminal, and the input audio signal may be transmitted to the communication unit of the electronic device 200 through Wi-Fi, Bluetooth, or infrared communication, but the disclosure is limited thereto.

The electronic device 200 according to an embodiment of the disclosure may obtain the first audio signal from the received first user voice input. In detail, the electronic device 200 may obtain the first audio signal from the first user voice input through an engine configured to recognize an audio signal. For example, the electronic device 200 may obtain the first audio signal from the first user voice input by using an engine that is configured to recognize an audio signal and is stored in the memory 210. Also, for example, the electronic device 200 may obtain the first audio signal from the first user voice input by using an engine that is configured to recognize an audio signal and is stored in a server, but is not limited thereto.

In operation S420, the electronic device according to an embodiment of the disclosure may obtain a second audio signal from a second user voice input subsequent to the first audio signal.

The electronic device may provide the user with an output related to a result of speech recognition on the first audio signal. For example, the user may be provided with an output related to a search result for the first audio signal, and thus determine whether the first user voice input has been accurately recognized. For example, according to the output related to the search result for the first audio signal, the user may determine, from the first audio signal, that the first user voice input has been misrecognized.

The electronic device 200 according to an embodiment of the disclosure may operate in the standby mode for receiving a second user voice input from the user in response to reception of one of at least one preset trigger word. In addition, in response to reception of one of the at least one preset trigger word, the electronic device 200 may request the user to utter a command-related voice input. However, when a preset period has not elapsed after the user utters the first user voice input, the user may directly input the second user voice input without inputting a separate trigger word to the electronic device, but the disclosure is not limited thereto.

The user may input, to the electronic device, the second user voice input for correcting the misrecognized first audio signal. The second user voice input may be an utterance input to correct the first audio signal, but is not limited thereto. For example, the second user voice input may be a new utterance having a meaning similar to that of the first user voice input, but having a pronunciation different from that of the first user voice input.

The electronic device 200 according to an embodiment of the disclosure may receive the second user voice input. As described above with reference to operation S410, the electronic device 200 may receive a voice of the user by using various methods, such as using the receiver 230, or an external electronic device or a portable terminal including a microphone.

The electronic device 200 according to an embodiment of the disclosure may obtain the second audio signal from the second user voice input. For example, the electronic device 200 may obtain the second audio signal from the second user voice input by using the engine that is configured to recognize an audio signal and is stored in the memory 210. Also, the electronic device 200 may obtain the second audio signal from the second user voice input by using an engine that is configured to recognize an audio signal and is stored in a server.

In operation S430, in a case in which the second audio signal is for correcting the first audio signal, the electronic device according to an embodiment of the disclosure may obtain, from the second audio signal, at least one of at least one corrected word or at least one corrected syllable.

The electronic device 200 according to an embodiment of the disclosure may identify whether the second audio signal obtained by performing speech recognition on the second user voice input is for correcting the previously obtained first audio signal. In detail, the electronic device 200 may identify, based on the similarity between the first audio signal and the second audio signal, at least one of whether the second audio signal has at least one vocal characteristic or whether a voice pattern of the second audio signal corresponds to at least one preset voice pattern.

In a case in which the similarity between the first audio signal and the second audio signal is greater than or equal to a preset threshold, the electronic device 200 according to an embodiment of the disclosure may identify whether the second audio signal has a vocal characteristic. In detail, the similarity between the first audio signal and the second audio signal may be calculated considering whether the numbers of syllables of the signals are identical to each other, whether syllables corresponding to each other in the respective signals are similar in pronunciation, and the like. In a case in which the similarity between the first audio signal and the second audio signal is greater than or equal to the preset threshold, the electronic device 200 may determine that the second audio signal is similar to the first audio signal.

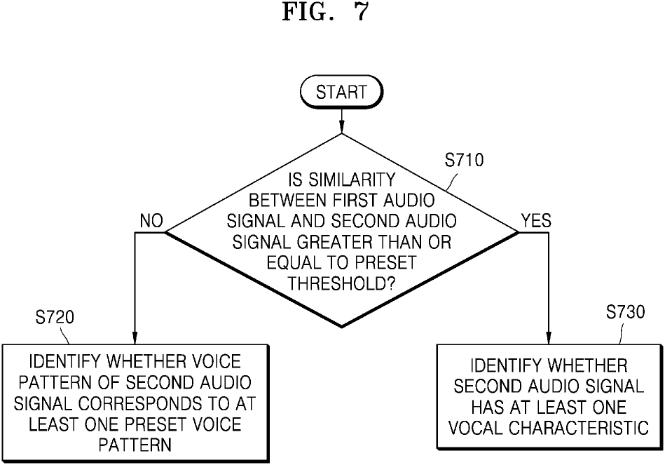

In a case in which the first audio signal according to an embodiment of the disclosure is a misrecognized audio signal, as an embodiment of the disclosure for correcting the misrecognized first audio signal, the user 100 may input, to the electronic device, the second user voice input in which a misrecognized part of the first audio signal is emphasized. Here, the second user voice input received by the electronic device 200 may be a voice input that is similar to the received first user voice input, but has been pronounced with a larger amplitude and accent given to the misrecognized part to emphasize it. Accordingly, the electronic device 200 may determine that the second audio signal obtained from the second user voice input is similar to the previously obtained first audio signal, but has a vocal characteristic that emphasizes the misrecognized part. In detail, in a case in which the first audio signal and the second audio signal are similar to each other, the electronic device 200 may identify, according to whether the second audio signal has a vocal characteristic, whether the second audio signal is for correcting the first audio signal. Here, the vocal characteristic may refer to a syllable having a characteristic or feature in pronunciation, among at least one syllable included in the received audio signal. A detailed operation of identifying whether the second audio signal has a vocal characteristic will be described in detail with reference to FIGS. 7 to 11.

In a case in which the similarity between the first audio signal and the second audio signal is less than the preset threshold value, the electronic device 200 according to an embodiment of the disclosure may identify whether the voice pattern of the second audio signal corresponds to the at least one preset voice pattern, by using a natural language processing model. Here, the at least one preset voice pattern may refer to a voice pattern of a voice uttered with an intention of correcting a misrecognized audio signal. In addition, the at least one preset voice pattern may refer to a voice pattern including a post-correction word and a post-correction syllable. For example, in a case in which an audio signal “It’s [symbol] in [symbol] [symbol] [symbol] is pronounced ‘rang’ and means ‘and’, and [symbol] is pronounced ‘neo-rang-na-rang’ and means ‘you and me’) is obtained, the electronic device 200 may analyze the context of the audio signal based on the natural language processing model, and thus identify “It’s [symbol] in [symbol] corresponds to “It’s B in A”, among the at least one preset voice pattern. In this case, [symbol] that occurs twice in [symbol] may be a post-correction syllable.

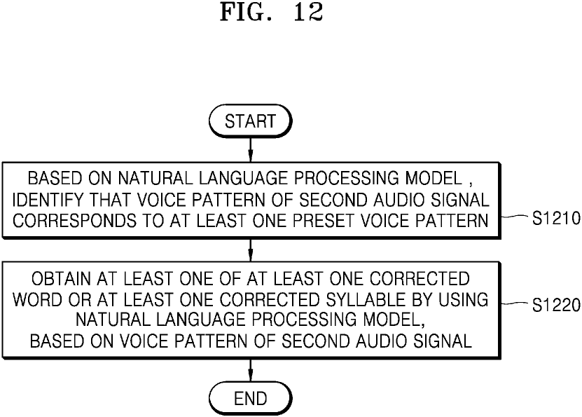

The at least one preset voice pattern according to an embodiment of the disclosure may include a complete voice pattern that includes both 1) a post-correction word and a post-correction syllable, and 2) a pre-correction word and a pre-correction syllable. For example, in a case in which an audio signal “Not [symbol] but [symbol] [symbol] is pronounced ‘tteu-ran-kkil-ro’ and is a misspelling of [symbol] that is pronounced ‘tteu-rang-kkil-ro’ and is the name of a content creator) is obtained, the electronic device 200 may analyze the context of the audio signal based on the natural language processing model, and thus identify that “Not [symbol] but [symbol] corresponds to “Not A but B”, among the at least one preset voice pattern. In this case, [symbol] corresponding to ‘B’ in “Not A but B” may a post-correction word, and [symbol] corresponding to ‘A’ in “Not A but B” may a pre-correction word. A detailed operation of identifying whether the voice pattern of the second audio signal corresponds to the at least one preset voice pattern will be described in detail with reference to FIGS. 12 to 19.

By identifying whether the second audio signal is for correcting the first audio signal, the electronic device 200 according to an embodiment of the disclosure may obtain, from the second audio signal, at least one of at least one corrected word or at least one corrected syllable. In detail, depending on whether the second audio signal has at least one vocal characteristic or whether the voice pattern of the second audio signal corresponds to the at least one preset voice pattern, the electronic device 200 may obtain, from the second audio signal, the at least one of the at least one corrected word or the at least one corrected syllable. As used herein, the at least one corrected word and the at least one corrected syllable may refer to a post-correction word and a post-correction syllable included in the second audio signal, respectively.

In a case in which the voice pattern of the second audio signal according to an embodiment of the disclosure is included in the at least one preset voice pattern, the electronic device 200 may identify at least one corrected word and at least one corrected syllable by identifying the context of the second audio signal by using a natural language processing model. In addition, in a case in which the second audio signal has a vocal characteristic, the electronic device 200 may identify at least one corrected word and at least one corrected syllable, based on first pronunciation information about at least one syllable included in the first audio signal and second pronunciation information about at least one syllable included in the second audio signal.

In detail, an operation of obtaining, from the second audio signal, the at least one of the at least one corrected word or the at least one corrected syllable will be described below together with a detailed operation of identifying whether the voice pattern of the second audio signal corresponds to the at least one preset voice pattern, and a detailed operation of identifying whether the second audio signal has a vocal characteristic.

In operation S440, the electronic device according to an embodiment of the disclosure may identify at least one corrected audio signal for the first audio signal, based on the at least one of the at least one corrected word or the at least one corrected syllable.

The electronic device according to an embodiment of the disclosure may identify the at least one corrected audio signal for the first audio signal, based on the obtained at least one of the at least one corrected word or the at least one corrected syllable. The electronic device 200 may identify at least one of at least one misrecognized word or at least one misrecognized syllable included in the first audio signal. A detailed method of identifying at least one of a misrecognized word or at least one misrecognized syllable may vary depending on embodiments of the disclosure. For example, an operation of identifying at least one of a misrecognized word or at least one misrecognized syllable may be performed differently according to a method of determining whether the second audio signal is for correcting the first audio signal. A detailed operation of identifying at least one of at least one misrecognized word or at least one misrecognized syllable will be described with reference to FIGS. 7 to 20.

The electronic device 200 according to an embodiment of the disclosure may identify the at least one corrected audio signal for the first audio signal, based on the identified at least one of the at least one misrecognized word or the at least one misrecognized syllable, and the at least one of the at least one corrected word or at least one corrected syllable.

The electronic device 200 according to an embodiment of the disclosure may clearly identify, based on the second audio signal, the at least one of the at least one corrected word or the at least one corrected syllable, and the at least one misrecognized word and the at least one misrecognized syllable, which are to be corrected. In a case in which the at least one misrecognized word and the at least one misrecognized syllable are clearly identified, the electronic device 200 may identify the at least one corrected audio signal for the first audio signal, by correcting the at least one misrecognized word and the at least one misrecognized syllable to the at least one of the at least one corrected word or at least one corrected syllable corresponding thereto.

For example, in a case in which the voice pattern of the second audio signal is a complete voice pattern, the electronic device 200 may accurately identify 1) the post-correction word and the post-correction syllable (may also be referred to as a corrected word and a corrected syllable throughout the specification), and 2) the pre-correction word and the pre-correction syllable, by identifying the context of the second audio signal through the natural language processing model. In addition, the electronic device 200 2) may obtain, from among at least one word and at least one syllable included in the first audio signal, the at least one of the at least one misrecognized word or the at least one misrecognized syllable corresponding to the pre-correction word and the pre-correction syllable. Accordingly, the electronic device 200 may identify the at least one corrected audio signal for the first audio signal, by correcting the at least one of the at least one misrecognized word or the at least one misrecognized syllable to the at least one of the at least one corrected word or the at least one corrected syllable.

However, in some cases, the pre-correction word and the pre-correction syllable are not clearly described in the second audio signal. For example, in a case in which the first audio signal includes a plurality of syllables having the same pronunciation as the corrected syllable included in the second audio signal, it may be difficult for the electronic device 200 to clearly specify the pre-correction syllable to be corrected.

In addition, in a case in which a newly input text other than those stored in a speech recognition engine (or a speech recognition database (DB)) is input as a voice, the electronic device may misrecognize the voice of the user. For example, a text related to a buzzword that has recently increased in popularity may not have been updated to the speech recognition engine yet, and thus, the electronic device may misrecognize the voice of the user. Thus, even in a case in which the at least one corrected word included in the second audio signal is not searched for by the engine for recognizing an audio signal, the electronic device 200 may obtain, from a ranking NE dictionary, at least one word similar to the at least one corrected word, and thus provide the user with at least one corrected audio signal suitable for the first audio signal. In detail, the electronic device 200 may provide the user with the at least one corrected audio signal suitable for the first audio signal, by obtaining the at least one word similar to the at least one corrected word, from an NE dictionary in the memory 210 or a server connected to the electronic device 200. In the specification, the NE dictionary may refer to an NE dictionary in a background app that searches for an audio signal according to a user voice input, and may include pieces of search data sorted according to search rankings of NEs.

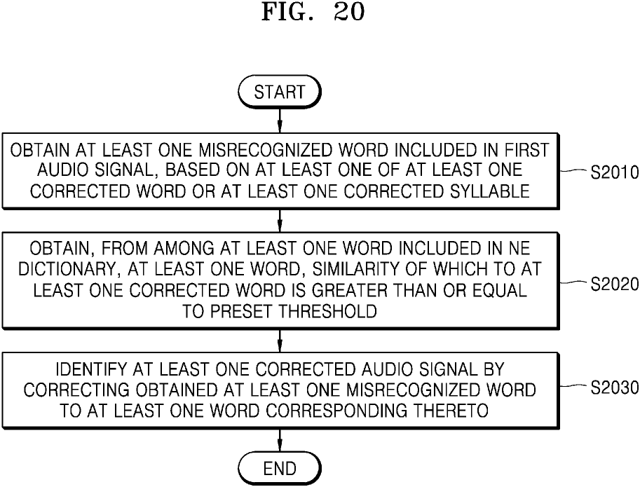

The electronic device 200 according to an embodiment of the disclosure may obtain, based on the at least one of the at least one corrected word or the at least one corrected syllable, the at least one misrecognized word included in the first audio signal, obtain, from among at least one word included in the NE dictionary, at least one word, the similarity to the at least one corrected word is greater than or equal to a preset first threshold, and identify the at least one corrected audio signal by correcting the obtained at least one misrecognized word to the at least one word corresponding thereto. A detailed operation related to the NE dictionary will be described in detail with reference to FIG. 20.

In operation S450, the electronic device according to an embodiment of the disclosure may process the at least one corrected audio signal.

The electronic device 200 according to an embodiment of the disclosure may process the at least one corrected audio signal. For example, the electronic device 200 may output, to the user, a search result for the at least one corrected audio signal. According to the output search result for the at least one corrected audio signal, the electronic device 200 may receive, from the user, a response signal related to misrecognition, and request the user to reutter according to the response signal.

FIG. 5 is a diagram illustrating in detail a method of processing a voice input of a user, according to an embodiment of the disclosure.

A trigger word “Bixby” 550 may be input from the user 100. For example, the electronic device 200 may receive the trigger word “Bixby” 550 from the user 100 through an external electronic device. The electronic device 200 that includes the receiver 230 may receive an utterance of the user through the receiver 230, whereas the electronic device 200 that does not include a separate receiver may receive an utterance of the user through an external electronic device. For example, in a case in which the external electronic device is an external control device, the external control device may receive a voice of the user through a built-in microphone, and the received voice may be digitized and then transmitted to the electronic device 200. In detail, the external control device may receive an analog voice of the user through a microphone, and the received analog voice may be converted into a digital audio signal.

In addition, for example, in a case in which the external electronic device that receives an audio signal is a portable terminal 510, the portable terminal 510 may operate as an external electronic device that receives an analog voice through a remote control app installed therein. In detail, the electronic device 200 may control a microphone built in the portable terminal 510 to receive a voice of the user 100 through the portable terminal 510 in which the remote control app is installed. In addition, the electronic device 200 may perform control such that an audio signal received by the portable terminal 510 is transmitted to the communication unit of the electronic device 200 through Wi-Fi, Bluetooth, or infrared communication. Throughout the specification, the communication unit of the electronic device 200 may be a communication unit configured to control the portable terminal 510, but is not limited thereto. In addition, referring to FIG. 5, the external electronic device that receives an audio signal may refer to the portable terminal 510, but is not limited thereto, and the external electronic device receiving an audio signal may refer to a portable terminal, a tablet PC, or the like.

In addition, although “Bixby” 550 uttered by the user 100 is described as an example, there is no limitation on how the electronic device 200 receives an utterance or a voice input of the user 100 in the specification, and the above-described method of receiving an utterance of the user 100 is equally applicable to “fairy” 570, which is a second voice input of the user 100.

The at least one trigger word according to an embodiment of the disclosure may be preset and stored in the memory of the electronic device 200. For example, the at least one trigger word may include at least one of “Bixby”, “Hi, Bixby”, or “Sammy”. A threshold used to determine whether a trigger word is included in an audio signal of the user 100 may vary depending on the trigger word. For example, a higher threshold may be set for “Sammy”, which has a small number of syllables, than that of “Bixby” or “Hi, Bixby”, which has a larger number of syllables. In addition, the user may adjust the threshold of at least one trigger word included in a trigger word list, and different thresholds may be set for different languages.

The electronic device 200 or a server 520 according to an embodiment of the disclosure may determine whether “Bixby” 550, which is a user voice input, is identical to a trigger word “Bixby”. As it is determined that the first user voice input “Bixby” 550 is identical to the trigger word “Bixby”, the electronic device 200 may output an audio signal “Yes. Bixby is here” 560 to request an additional command related to a command of the user and operate in the standby mode for receiving an utterance of the user. In addition, the electronic device 200 may output a UI related to “Yes. Bixby is here”, through the display unit 241 of the electronic device 200 or a separate display device 530 in order to request an additional command related to a command of the user, but the disclosure is not limited thereto.

In response to reception of the audio signal “Yes. Bixby is here” 560, the user 100 may input “fairy” 570 as the first user voice input, and the first user voice input may be a voice uttered for search. The electronic device 200 may receive the first user voice input “fairy” 570. However, the voice input of the user 100 and the audio signal recognized by the electronic device 200 may be different from each other, and referring to FIG. 5, the electronic device 200 may misrecognize “fairy” 570 as “ferry” 580, which is a first audio signal. In detail, the first user voice input “fairy” 570 and the first audio signal “ferry” 580 have the same pronunciation ‘feri’, and thus, the electronic device 200 may misrecognize “fairy” 570 as “ferry” 580.

The electronic device 200 according to an embodiment of the disclosure may output a search result for the misrecognized “ferry” 580, as an audio signal 590 or a UI 540 on the display device 530, and the user 100 may recognize that the electronic device 200 has misrecognized “fairy” 570 as “ferry” 580.

FIG. 6 is a diagram illustrating in detail a method, which is subsequent to the method of FIG. 5, of processing a voice input of a user, according to an embodiment of the disclosure.

Continuing from FIG. 5, the user 100 may input an utterance for correcting the misrecognized “ferry” 580. However, before inputting the second user voice input for correcting the misrecognized “ferry” 580, as illustrated in FIG. 5, the user 100 may input “Bixby” 610, which is a trigger word. As the electronic device 200 receives “Bixby” 610 and determines that “Bixby” 610 is identical to the trigger word “Bixby”, the electronic device 200 may output an audio signal “Yes. Bixby is here” 620 for requesting an additional command related to a command of the user, and operate in the standby mode for receiving an utterance from the user 100.

The user 100 may input, to the electronic device 200, an utterance for explaining the difference between the misrecognized “ferry” and the word “fairy” to search for. For example, “ferry” and “fairy” have different second and third letters, i.e., “e” and “r”, and “a” and “i”, and the user 100 may input, the electronic device 200, an utterance for explaining the difference. The user 100 may input a second user voice input “Not e(...)r, but a(...)i” 630, and the electronic device 200 may receive the second user voice input through a communication unit of the portable terminal 510. The electronic device 200 may obtain a second audio signal “Not e(...)r, but a(...)i” 635 through a speech recognition engine.

The electronic device 200 according to an embodiment of the disclosure may determine, through a natural language processing model, that “Not e(...)r, but a(...)i” 635 corresponds to “Not A, but B” among at least one preset voice pattern. Accordingly, the electronic device 200 may determine, through the natural language processing model, that the context of “Not e(...)r, but a(...)i” 635 is to explain that it is not “e(...)r” but “a(...)i”. The electronic device 200 may determine that “a” and “i” included in the second audio signal correspond to post-correction letters. In addition, the electronic device 200 may identify, through the natural language processing model, “e” and “r” as letters to be corrected, from “Not e(...)r, but a(...)i” 635.

The electronic device 200 according to an embodiment of the disclosure may identify, as a letter to be corrected, “e”, which is the second letter of “ferry”, by comparing “ferry” 580, which is the first audio signal, with “e” and “r”, which are the letters to be corrected. In addition, both the third letter “r” and the fourth letter “r” included in “ferry” may be identified as letters to be corrected. However, in the embodiment of FIG. 6, because the electronic device 200 cannot accurately determine which of the third letter “r” and the fourth letter “r” included in “ferry” is actually to be corrected, the electronic device 200 may obtain at least one word by using an NE dictionary 645 in order to more accurately predict at least one corrected audio signal.

The electronic device 200 according to an embodiment of the disclosure may identify at least one corrected word 640 by correcting the letters to be corrected to “a” and “i”, which are post-correction letters, respectively. For example, 1) when only the third letter “r” of “ferry” is corrected, the corrected word may be “fairy”, 2) when only the fourth letter “r” of “ferry” is corrected, the corrected word may be “fariy”, and 3) when both the third letter “r” and the fourth letter “r” of “ferry” are corrected, the corrected word may be “faiiy”.

The electronic device 200 according to an embodiment of the disclosure may obtain “fairy” 650, which is at least one word, the similarity of which is greater than or equal to a preset threshold, by searching the NE dictionary for “fairy”, “fariy”, and “faiiy”, which are the at least one corrected word 640. For example, referring to FIG. 6, because there is no word, the similarity to “fariy” and “faiiy” is greater than or equal to the preset threshold among at least one word included in the NE dictionary 645, the electronic device 200 may obtain “fairy” 650, which is the at least one word.

Obtaining a first audio signal from a first user voice input of the user, obtaining a second audio signal from a second user voice input of the user that is subsequent to the first audio signal, based on the second audio signal being for correcting the first audio signal, obtaining, from the second audio signal of the user, at least one of at least one corrected word or at least one corrected syllable, based on the at least one of the at least one corrected word or the at least one corrected syllable, identifying at least one corrected audio signal for the first audio signal, and processing the at least one corrected audio signal, according to an embodiment of the disclosure may be performed by the electronic device 200 and the server 520 in combination. The electronic device 200 may operate as an electronic device that processes a voice input of the user by communicating with the server 520 through a Wi-Fi module or an Ethernet module of the communication unit. In the specification, the communication unit 250 of the electronic device 200 may include the Wi-Fi module or the Ethernet module to perform all of the above operations, but is not limited thereto.

In addition, for example, the obtaining, from the second audio signal of the user, of the at least one of the at least one corrected word or the at least one corrected syllable, based on the second audio signal being for correcting the first audio signal, the identifying, based on the at least one of the at least one corrected word or the at least one corrected syllable, of the at least one corrected audio signal for the first audio signal, and the processing of the at least one corrected audio signal may be performed by the server 520, and search information for the identified at least one corrected audio signal may be output as an audio signal 660 through the audio output unit 242 of the electronic device 200 or displayed through a UI of the display device 530.

The electronic device 200 according to an embodiment of the disclosure does not necessarily include the display unit, and the electronic device 200 of FIGS. 5 and 6 may be a set-top box without a separate display unit, or an electronic device including a simple display unit for displaying a notification. The external electronic device 530 including a display unit may be connected to the electronic device 200 to output, through the display unit, search information related to a recognized audio signal as a UI. For example, referring to FIG. 6, the external electronic device 530 may output search information for “fairy” through the display unit.

For example, the external electronic device 530 may be connected to the electronic device 200 through the external device interface unit 270, and thus may receive, from the electronic device 200, a signal for the search information related to the recognized audio signal, and output, through the display unit, the search information related to the recognized audio signal. In detail, the external device interface unit may include at least one of an HDMI port, a DP port, or a Thunderbolt port, but is not limited thereto. Also, for example, the external electronic device 530 may receive, from the electronic device 200, the signal for the search information related to the recognized audio signal, based on wireless communication with the electronic device 200, and output the signal through the display unit, but is not limited thereto.

The electronic device 200 according to an embodiment of the disclosure may receive utterances of the user in various languages, identify an intention of the user 100 to correct audio signals in various languages, and thus provide appropriate responses to the utterances. For example, the examples in English and Korean are used in the specification with reference to FIGS. 5 and 6, but the disclosure is not limited to audio signals in English and Korean.

FIG. 7 is a flowchart illustrating in detail a method of identifying, based on the similarity between a first audio signal and a second audio signal, at least one of whether the second audio signal has at least one vocal characteristic or whether a voice pattern of the second audio signal corresponds to at least one preset voice pattern, according to an embodiment of the disclosure.

The electronic device 200 according to an embodiment of the disclosure may identify, based on the similarity between the first audio signal and the second audio signal, at least one of whether the second audio signal has at least one vocal characteristic or whether the voice pattern of the second audio signal corresponds to the at least one preset voice pattern.

In operation S710, the electronic device 200 according to an embodiment of the disclosure may determine whether the similarity between the first audio signal and the second audio signal is greater than or equal to a preset threshold.

The electronic device 200 according to an embodiment of the disclosure may first determine the similarity between the first audio signal and the second audio signal before determining whether the second audio signal is for correcting the first audio signal. For example, the electronic device 200 or a server for processing a voice input of a user may determine the similarity between the first audio signal and the second audio signal according to probability information about the degree to which the first audio signal and the second audio signal match each other, based on an acoustic model that is trained based on acoustic information. The acoustic model that is trained based on the acoustic information may be stored in the memory 210 of the electronic device 200 or in the server, but is not limited thereto.

The electronic device 200 according to an embodiment of the disclosure may determine whether the similarity between the first audio signal and the second audio signal is greater than or equal to the preset threshold. The preset threshold may be adjusted by the user through the user input unit 260 of the electronic device 200, or may be adaptively adjusted by the server (not shown). Also, the preset threshold may be stored in the memory 210 of the electronic device 200.

The second audio signal according to an embodiment of the disclosure may be an audio signal for correcting the first audio signal. For example, in a case in which a second user voice input is similar to a first user voice input, the second user voice input may be an audio input in which a misrecognized word or a misrecognized syllable in the first audio signal are emphasized. In addition, in a case in which the second user voice input is not similar to the first user voice input, the second user voice input may be an utterance for explaining how to correct the misrecognized word or the misrecognized syllable.

In operation S720, in a case in which the similarity between the first audio signal and the second audio signal is less than the preset threshold value, the electronic device 200 according to an embodiment of the disclosure may identify whether the voice pattern of the second audio signal corresponds to the at least one preset voice pattern.

In a case in which the similarity between the first audio signal and the second audio signal is less than the preset threshold, the electronic device 200 according to an embodiment of the disclosure may determine that the second audio signal and the first audio signal are not similar to each other. Based on determining that the second audio signal and the first audio signal are not similar to each other, the electronic device 200 may identify whether the second audio signal is a signal describing how to correct the misrecognized word included in the first audio signal or the misrecognized syllable included in the first audio signal, by identifying the context of the second audio signal, based on the natural language processing model. In addition, based on the natural language processing model, the electronic device 200 may identify that the voice pattern of the second audio signal is included in at least one preset voice pattern, and the electronic device 200 may identify at least one of at least one corrected word or at least one corrected syllable included in the second audio signal by using the pattern of the second audio signal. A detailed operation of identifying whether the voice pattern of the second audio signal corresponds to the at least one preset voice pattern will be described in detail with reference to FIGS. 12 to 19.

In operation S730, in a case in which the similarity between the first audio signal and the second audio signal is greater than or equal to the preset threshold, the electronic device 200 according to an embodiment of the disclosure may identify whether the second audio signal has at least one vocal characteristic.

In a case in which the similarity between the first audio signal and the second audio signal is greater than or equal to the preset threshold, the electronic device 200 according to an embodiment of the disclosure may determine that the second audio signal and the first audio signal are similar to each other. Based on a result of determining the similarity between the second audio signal and the first audio signal, the electronic device 200 may obtain second pronunciation information for each of at least one syllable included in the second audio signal. Here, the second pronunciation information may include at least one of accent information, amplitude information, or duration information for each of the at least one syllable included in the second audio signal.

The electronic device 200 according to an embodiment of the disclosure may identify, based on the second pronunciation information, whether the at least one syllable included in the second audio signal has at least one vocal characteristic. In order to emphasize at least one syllable among the at least one syllable included in the second audio signal that is determined as having been misrecognized, the user may 1) pronounce, with an accent, the at least one syllable determined as having been misrecognized, 2) pronounce the at least one syllable louder than other syllables, and 3) pause before pronouncing the at least one syllable.

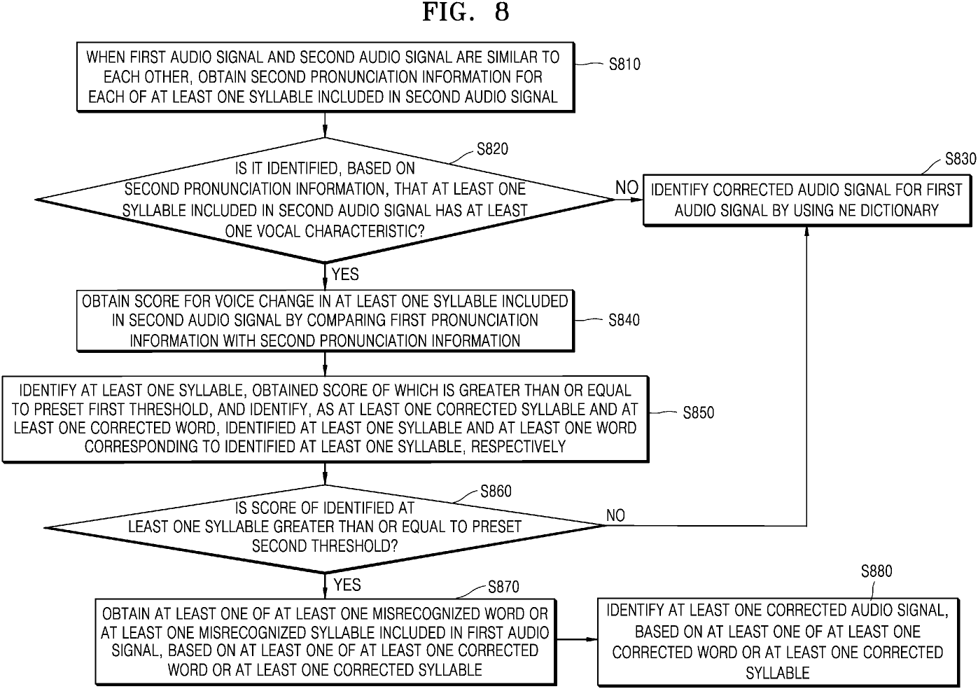

Therefore, the electronic device 200 may identify, based on the second pronunciation information for each syllable included in the second audio signal, whether the at least one syllable included in the second audio signal has at least one vocal characteristic. Here, the at least one vocal characteristic may refer to at least one syllable pronounced by the user with emphasis. A detailed operation of identifying whether the second audio signal has at least one vocal characteristic will be described in detail with reference to FIGS. 8 to 11.

FIG. 8 is a flowchart illustrating in detail a method of, in a case in which a first audio signal and a second audio signal are similar to each other, identifying at least one corrected audio signal for the first audio signal according to whether at least one syllable included in the second audio signal has at least one vocal characteristic, according to an embodiment of the disclosure.

In operation S810, in a case in which the first audio signal and the second audio signal are similar to each other, the electronic device 200 according to an embodiment of the disclosure may obtain second pronunciation information for each of the at least one syllable included in the second audio signal.

In a case in which the similarity between the first audio signal and the second audio signal is greater than or equal to a preset first threshold, the electronic device 200 according to an embodiment of the disclosure may determine that the first audio signal and the second audio signal are similar to each other.

In order to determine whether the second audio signal is for correcting the first audio signal, the electronic device 200 according to an embodiment of the disclosure may obtain second pronunciation information for each of the at least one syllable included in the second audio signal. Here, the second pronunciation information may include at least one of accent information, amplitude information, or duration information for each of the at least one syllable included in the second audio signal, but is not limited thereto. For example, the second pronunciation information may also include information about a pronunciation in a case of emphasizing a particular syllable, according to a language. For example, unlike other languages, Chinese is a tonal language, and thus, pronunciation information in Chinese may include, in addition to accent information, duration information, and loudness information, information about 1) a time period taken to pronounce a syllable and 2) a change in pitch when pronouncing a syllable.

Accent information for each of at least one syllable included in an audio signal according to an embodiment of the disclosure may refer to pitch information for each of the at least one syllable. Amplitude information for each of at least one syllable may refer to loudness information for each of the at least one syllable. Duration information for each of at least one syllable may include at least one of information about the interval between at least one syllable and a syllable pronounced immediately before the at least one syllable, or information about the interval between at least one syllable and a syllable pronounced immediately after the at least one syllable.

In operation S820, the electronic device 200 according to an embodiment of the disclosure may identify, based on the second pronunciation information, whether the at least one syllable included in the second audio signal has at least one vocal characteristic.

In order to identify whether the second audio signal similar to the first audio signal is for correcting the first audio signal, the electronic device 200 according to an embodiment of the disclosure may identify, based on the second pronunciation information, whether the at least one syllable included in the second audio signal has at least one vocal characteristic. In the disclosure, the vocal characteristic may refer to a syllable having a vocal feature, among the at least one syllable included in the second audio signal. The electronic device 200 may perform speech analysis on the second audio signal based on the second pronunciation information, and determine, based on a result of the speech analysis, which word or syllable from among the at least one syllable included in the second audio signal is emphasized by the user. For example, the electronic device 200 may identify a particular syllable having a sound pressure level (dB) greater than those of other syllables included in the second audio signal by a preset threshold or greater, and identify the identified syllable as a vocal characteristic of the second audio signal. In addition, in a case in which a particular syllable having a pitch greater than those of other syllables included in the second audio signal by a preset threshold or greater is identified, the electronic device 200 may identify the identified syllable as a vocal characteristic of the second audio signal. The vocal characteristic may refer to at least one syllable determined as having been pronounced by the user with emphasis. Also, the vocal characteristic may refer to a word including at least one syllable determined having been uttered by the user with emphasis.

The electronic device 200 according to an embodiment of the disclosure may obtain a score related to whether each of the at least one syllable included in the second audio signal has a vocal characteristic, by comprehensively considering the accent information, the amplitude information, and the duration information for each of the at least one syllable. The electronic device 200 may determine, as a vocal characteristic, the at least one syllable, the obtained score of which is greater than or equal to a preset threshold.

In operation S830, in a case in which the second audio signal does not have at least one vocal characteristic, the electronic device 200 according to an embodiment of the disclosure may identify a corrected audio signal for the first audio signal by using an NE dictionary.

In a case in which the electronic device 200 according to an embodiment of the disclosure identifies that the second audio signal does not include at least one vocal characteristic, the electronic device 200 may identify the corrected audio signal for the first audio signal by using the NE dictionary. For example, in a case in which the electronic device 200 identifies that the second audio signal does not include at least one vocal characteristic, it may be difficult to determine that the second audio signal is for correcting the first audio signal. However, because the second audio signal is similar to the first audio signal, the electronic device 200 may more accurately identify at least one corrected audio signal by searching the NE dictionary. In detail, the electronic device 200 may obtain at least one word similar to at least one of the first audio signal or the second audio signal, by searching an NE dictionary of a background app for at least one of the first audio signal or the second audio signal. For example, the electronic device 200 may search the NE dictionary of the background app for a second audio signal [symbol] and thus obtain at least one word [symbol] having the same pronunciation. In addition, in a case in which the second audio signal is “Search for [symbol] the electronic device 200 may analyze the context by using a natural language processing model, thus search the NE dictionary of the background app for only [symbol] in the second audio signal, and obtain at least one word [symbol] having the same pronunciation.

The electronic device 200 according to an embodiment of the disclosure may obtain, based on the at least one word, at least one corrected audio signal from the first audio signal and the second audio signal. The electronic device 200 may identify the at least one corrected audio signal by correcting, to the obtained at least one word, a word included in the first audio signal and a word included in the second audio signal, which correspond to the at least one word.

In operation S840, the electronic device 200 according to an embodiment of the disclosure may obtain first pronunciation information for each of at least one syllable included in the first audio signal, and obtain a score for a voice change in the at least one syllable included in the second audio signal by comparing the first pronunciation information with the second pronunciation information.

It may be insufficient to use only the second pronunciation information of the second audio signal to determine whether the second audio signal is for correcting the first audio signal. For example, a particular flow may be included in at least one word or at least one syllable included in the second audio signal, according to language and linguistic characteristics of words. Accordingly, it may be insufficient for the electronic device to use only the pronunciation information of the second audio signal to accurately identify whether the intention of the user is to correct the first audio signal. Accordingly, the electronic device 200 may obtain the first pronunciation information for each of the at least one syllable included in the first audio signal, and accurately identify at least one corrected syllable among the at least one syllable included in the second audio signal by comparing the first pronunciation information with the second pronunciation information.

In a case in which at least one syllable included in the second audio signal has at least one vocal characteristic, the electronic device 200 according to an embodiment of the disclosure may obtain the first pronunciation information for each of the at least one syllable included in the first audio signal in order to determine a voice change in the at least one syllable included in the second audio signal.

The electronic device 200 according to an embodiment of the disclosure may obtain a score for a voice change in the at least one syllable included in the second audio signal by comparing the first pronunciation information with the second pronunciation information. For example, Score(syllable), which is a score for a voice change in the at least one syllable included in the second audio signal, may be obtained as follows.

Score(Syllable)
= ΔScore1(accent, Syllable) + ΔScore2(amplitude, Syllable)
+ ΔScore3(duration, Syllable)

Here, ΔScore1(accent, Syllable) may denote a change score of accent information for each syllable included in the second audio signal, ΔScore2(amplitude, Syllable) may denote a change score of amplitude information for each syllable included in the second audio signal, and ΔScore3(duration, Syllable) may denote a change score of duration information for each syllable included in the second audio signal. For example, in order to emphasize a particular syllable, the user may 1) pronounce the syllable with a higher pitch and louder, and thus, ΔScore1 and ΔScore2 may represent functions proportional to accent and amplitude, respectively. In addition, duration may refer to information about the interval between a particular syllable and a syllable pronounced before the particular syllable. Accordingly, in a case in which the user emphasizes a particular syllable, the user may pause for a certain interval or longer between the particular syllable and the syllable pronounced before the particular syllable. Therefore, ΔScore3 may be proportional to duration.

In operation S850, the electronic device 200 according to an embodiment of the disclosure may identify at least one syllable, the obtained score of which is greater than or equal to the preset first threshold, and identify, as at least one corrected syllable and at least one corrected word, the identified at least one syllable and at least one word corresponding to the identified at least one syllable, respectively.

The electronic device 200 according to an embodiment of the disclosure may identify at least one syllable, the score of which obtained in operation S840 is greater than or equal to the preset first threshold. Because the identified at least one syllable corresponds to a syllable having a large change in vocal characteristic among the at least one syllable included in the second audio signal, and the electronic device 200 may identify, as at least one corrected syllable and at least one corrected word, the identified at least one syllable and at least one word corresponding to the identified at least one syllable.

Because the electronic device 200 according to an embodiment of the disclosure has identified at least one of at least one corrected syllable or at least one corrected word, the electronic device 200 needs to identify at least one of at least one misrecognized syllable or at least one misrecognized word to be corrected, in order to determine at least one corrected audio signal.

According to the score of the identified at least one syllable, the electronic device 200 according to an embodiment of the disclosure may identify at least one corrected audio signal through different processes respectively for a case in which the intention of the user to correct is significantly clear and a case in which the intention of the user to correct is clear to a certain extent. In detail, the electronic device 200 may identify at least one of at least one misrecognized syllable or at least one misrecognized word to be corrected, through a process that depends on the obtained score, but is not limited thereto. For example, in a case in which, regardless of the score, the second audio signal has a vocal characteristic according to operation S820, the electronic device 200 may more accurately identify at least one corrected audio signal for the first audio signal by using the NE dictionary. Operations S860 to S880 below describe an embodiment of the disclosure of identifying at least one corrected audio signal through different processes.

In operation S860, the electronic device 200 according to an embodiment of the disclosure may determine whether the score of the identified at least one syllable is greater than or equal to a preset second threshold.

The electronic device 200 according to an embodiment of the disclosure may determine whether the score of the identified at least one syllable is greater than or equal to the preset second threshold. Here, the second threshold may be a value greater than the first threshold of operation S840. In a case in which the score of the identified at least one syllable is greater than or equal to the preset second threshold, a score for a change in vocal characteristic obtained based on the first pronunciation information and the second pronunciation information is significantly high. Accordingly, the electronic device 200 may determine that at least one syllable having a score for a voice change greater than or equal to the second threshold is a syllable for which the intention of the user to correct is significantly clear. In the specification, in order to quickly provide the user with search information for the corrected audio signal, in a case in which the intention of the user to correct is clear, the electronic device 200 may identify the corrected audio signal for the first audio signal without an operation of searching the NE dictionary, but is not limited thereto.

In a case in which the score of the identified at least one syllable is less than the preset second threshold, the electronic device 200 may identify the corrected audio signal for the first audio signal by using the NE dictionary (operation S830).

In a case in which the electronic device 200 according to an embodiment of the disclosure determines that the score of the identified at least one syllable is less than the preset second threshold, the electronic device 200 may identify, as a syllable for which the intention of the user to correct is clear to a certain extent, at least one syllable, the score for a voice change of which is less than the second threshold. Accordingly, the electronic device may more accurately identify the corrected audio signal for the first audio signal by additionally using the NE dictionary.

The electronic device 200 according to an embodiment of the disclosure may identify, from the first audio signal, at least one misrecognized word or at least one misrecognized syllable corresponding to at least one corrected syllable and at least one corrected word including the at least one corrected syllable. For example, in a case in which the second audio signal is [symbol] and the first audio signal is [symbol] the syllable [symbol] of the second audio signal may correspond to the at least one misrecognized syllable. In addition, because [symbol] of the second audio signal is similar in pronunciation to [symbol] of the first audio signal [symbol] and they correspond in position to each other as they are the second syllables, the electronic device 200 may identify, as the at least one misrecognized syllable, [symbol] of the first audio signal. [symbol] In addition, the electronic device 200 may identify, as the at least one misrecognized word, [symbol] including [symbol] which is the at least one misrecognized syllable.

The electronic device 200 according to an embodiment of the disclosure may obtain, from among at least one word included in the NE dictionary, at least one word, the similarity of which to the at least one corrected word is greater than or equal to a preset threshold. Because the electronic device 200 has identified, as a syllable for which the intention of the user to correct is clear to a certain extent, the at least one syllable, the score for a voice change of which is less than the second threshold, the electronic device 200 may more accurately identify the corrected audio signal for the first audio signal by additionally obtaining the at least one word.

In operation S870, based on at least one of the at least one corrected word or the at least one corrected syllable, the electronic device 200 according to an embodiment of the disclosure may obtain at least one of at least one misrecognized word or at least one misrecognized syllable included in the first audio signal.

The electronic device 200 according to an embodiment of the disclosure may obtain, as the at least one misrecognized syllable, a syllable similar to the at least one corrected syllable identified in operation S850, from among the at least one syllable included in the first audio signal. In addition, the electronic device 200 may obtain, as the at least one misrecognized word, at least one word including the at least one misrecognized syllable.

In operation S880, the electronic device 200 according to an embodiment of the disclosure may identify at least one corrected audio signal, based on the at least one of the at least one corrected word or the at least one corrected syllable.

The electronic device 200 according to an embodiment of the disclosure may determine, as a target to be corrected in the first audio signal, the at least one of the at least one misrecognized word or the at least one misrecognized syllable identified in operation S870. Accordingly, the electronic device may identify the at least one corrected audio signal for the first audio signal, by correcting the at least one of the at least one misrecognized word or the at least one misrecognized syllable to the at least one of the at least one corrected word or the at least one corrected syllable.

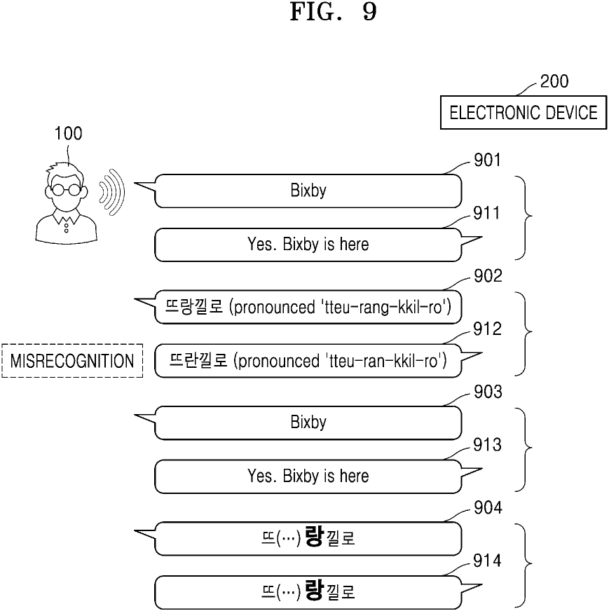

FIG. 9 is a diagram illustrating a detailed method of identifying at least one corrected audio signal according to whether at least one syllable included in a second audio signal includes at least one vocal characteristic.

Referring to FIG. 9, in response to reception of “Bixby” 901 from the user 100, the electronic device 200 may output an audio signal “Yes. Bixby is here” 911 to request the user to speak a command-related utterance. Accordingly, the user 100 may input a first user voice input [symbol] 902 to the electronic device 200, but the electronic device 200 may misrecognize the first user voice input [symbol] 902 as [symbol] 912, which is a first audio signal.

The user 100 may input a second user voice input to the electronic device 200 to correct the first audio signal [symbol] 912. Before inputting the second user voice input to the electronic device 200, the user 100 may speak “Bixby” 903 and then receive an audio signal “Yes. Bixby is here” 913 from the electronic device.

In order to emphasize [symbol] in the first user voice input compared to the misrecognized syllable [symbol] in the first audio signal, the user 100 strongly utters [symbol] included in the second user voice input. For example, the user 100 may input a second user voice input [symbol] 904 to the electronic device 200, by 1) pausing for a certain time interval between [symbol] and [symbol] included in the second user voice input, and 2) pronouncing [symbol] aloud with a high pitch.

The electronic device 200 according to an embodiment of the disclosure may receive the second user voice input [symbol] 904, and obtain a second audio signal [symbol] 914, through a speech recognition engine. Based on the second audio signal [symbol] 904, the electronic device 200 may identify whether the second audio signal is for correcting the first audio signal

[symbol]

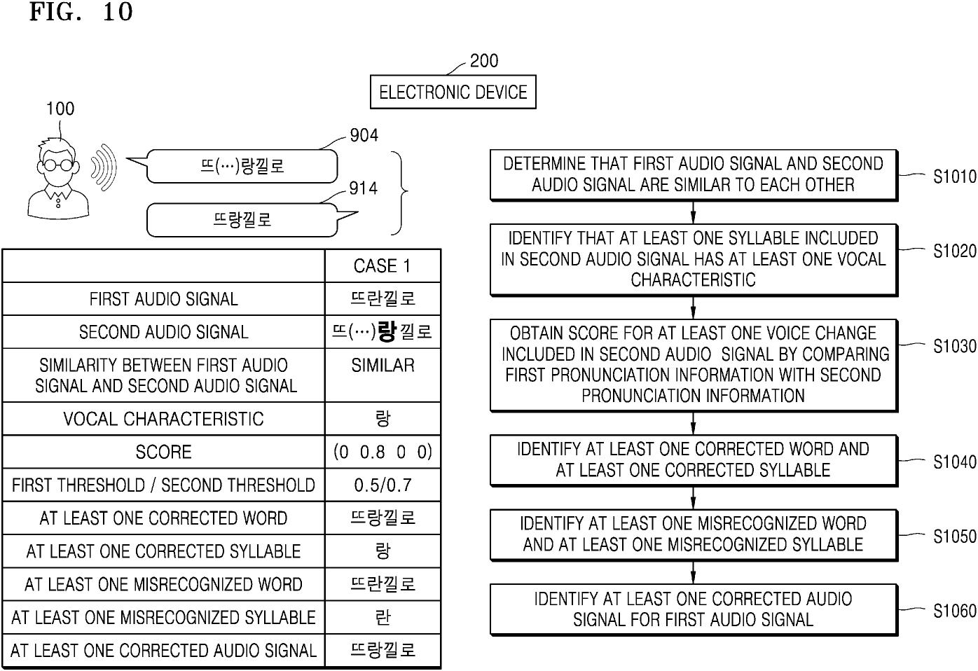

FIG. 10 is a diagram illustrating a detailed method, which is subsequent to the method of FIG. 9, of identifying at least one corrected audio signal according to whether at least one syllable included in a second audio signal includes at least one vocal characteristic.

Referring to FIG. 10, the electronic device 200 may identify, based on the second audio signal [symbol] 904, whether the second audio signal is for correcting the first audio signal [symbol] and identify at least one corrected audio signal for the first audio signal according to the identifying.

In operation S1010, the electronic device 200 may determine that the first audio signal and the second audio signal are similar to each other.

The electronic device 200 according to an embodiment of the disclosure may determine that 1) the first audio signal [symbol] and the second audio signal [symbol] are four-syllable words, and 2) the initial consonants, medial vowel, and final consonants of their syllables are almost the same as each other, respectively. Accordingly, the electronic device 200 may determine that the first audio signal and the second audio signal are similar to each other. In detail, in a case in which the similarity between the first audio signal and the second audio signal is greater than or equal to a preset threshold, the electronic device 200 may determine that the first audio signal and the second audio signal are similar to each other.

In operation S1020, the electronic device 200 may identify that at least one syllable included in the second audio signal has at least one vocal characteristic.

The electronic device 200 according to an embodiment of the disclosure may identify, based on second pronunciation information for the at least one syllable included in the second audio signal, whether the at least one syllable included in the second audio signal has at least one vocal characteristic. Referring to FIG. 10, considering that 1) the second syllable [symbol] has been pronounced aloud with a high pitch, and 2) there is an interval greater than or equal to a preset threshold between [symbol] and the first syllable [symbol] The electronic device 200 may identify, as a vocal characteristic, the second syllable [symbol] among the at least one syllable included in the second audio signal. However, the disclosure is not limited thereto, and the electronic device 200 according to an embodiment of the disclosure may determine, based on the second pronunciation information, that the at least one syllable included in the second audio signal does not have at least one vocal characteristic, and perform an operation of identifying a corrected audio signal for the first audio signal by using the NE dictionary corresponding to operation S830 of FIG. 8. However, hereinafter, a case in which the at least one syllable included in the second audio signal has at least one vocal characteristic will be described in detail according to a particular embodiment of the disclosure corresponding to FIG. 10.

In operation S1030, the electronic device 200 may obtain a score for at least one voice change included in the second audio signal by comparing the first pronunciation information with the second pronunciation information.

The electronic device 200 according to an embodiment of the disclosure may obtain a score for a voice change in the at least one syllable included in the second audio signal by comparing the first pronunciation information with the second pronunciation information. For example, the electronic device may obtain Score(syllable), which is a score for a voice change in the at least one syllable included in the second audio signal. For example, based on the first pronunciation information and the second pronunciation information, the electronic device 200 may obtain [symbol] [symbol] [symbol] and [symbol] as 0, 0.8, 0, and 0, respectively.

In operation S1040, the electronic device 200 may identify at least one corrected word and at least one corrected syllable.

As described above with reference to FIG. 8, because the score of the second syllable [symbol] among the at least one syllable included in the second audio signal is 0.8 and is greater than a first threshold of 0.5, the electronic device 200 may identify the second syllable [symbol] as the at least one corrected syllable. In addition, [symbol] including [symbol] which is the at least one corrected syllable, may also be included in the at least one corrected word.

In operation S1050, the electronic device 200 may identify at least one misrecognized word and at least one misrecognized syllable.

As described above with reference to FIG. 8, because the score of 0.7 for a voice change in the at least one corrected syllable [symbol] is greater than a second threshold of 0.8, the electronic device 200 according to an embodiment of the disclosure may identify the at least one misrecognized syllable without additionally searching the NE dictionary. For example, considering that the user has uttered the at least one corrected syllable [symbol] with great emphasis, the electronic device 200 may identify the at least one misrecognized syllable without additionally searching the NE dictionary, in order to quickly provide the user 100 with search information for the at least one corrected word. However, the disclosure is not limited thereto, and in a case in which the score for the voice change is greater than the second threshold of 0.8, the electronic device 200 according to an embodiment of the disclosure may identify the corrected audio signal for the first audio signal by using the NE dictionary. However, hereinafter, a case in which the at least one misrecognized syllable is identified without additionally searching the NE dictionary will be described in detail according to a particular embodiment of the disclosure corresponding to FIG. 10.

The electronic device 200 according to an embodiment of the disclosure may identify the at least one misrecognized syllable by measuring the similarity between the at least one corrected syllable [symbol] and at least one syllable included in the first audio signal [symbol] For example, 1) [symbol] is similar to [symbol] in that they have initial consonants, medial vowels, and final consonants, 2) [symbol] and [symbol] have the same initial consonant and medial vowel, and 3) [symbol] and [symbol] may be the same as each other in that they are the second syllables. Accordingly, the electronic device 200 may identify at least one misrecognized syllable [symbol] based on the at least one corrected syllable [symbol] and the first audio signal [symbol] In addition, the electronic device 200 may identify, as the at least one misrecognized word, [symbol] including the at least one misrecognized syllable

In operation S1060, the electronic device 200 may identify at least one corrected audio signal for the first audio signal.

The electronic device 200 according to an embodiment of the disclosure may identify the at least one corrected audio signal [symbol] for the first audio signal [symbol] by correcting the at least one misrecognized syllable [symbol] to the at least one corrected syllable

[symbol]

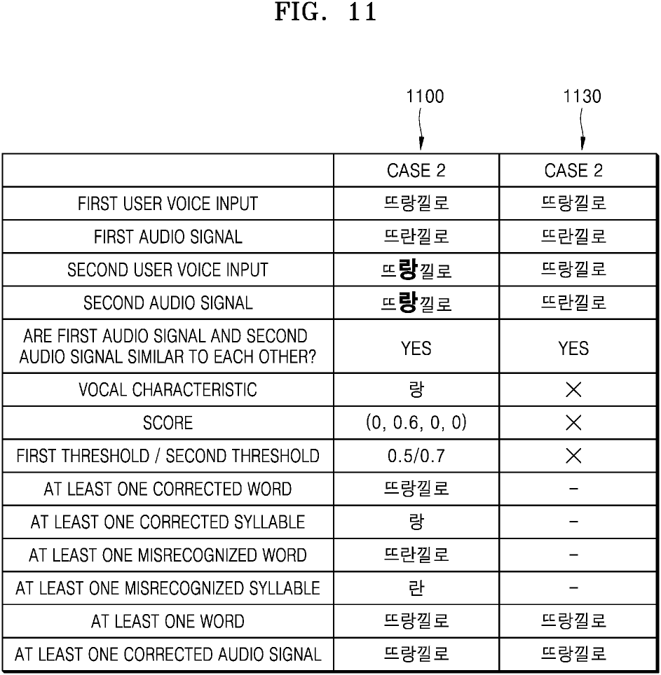

FIG. 11 is a diagram illustrating a detailed embodiment of the disclosure of identifying at least one corrected audio signal according to whether at least one syllable included in a second audio signal has at least one vocal characteristic, according to an embodiment of the disclosure.

Referring to FIG. 11, Case 2 1100 represents a case in which the second user voice input is [symbol] with emphasis on [symbol] and Case 3 1130 represents a case in which the second user voice input is [symbol] A method, performed by the electronic device 200, of identifying at least one corrected audio signal according to whether at least one syllable included in the second audio signal has at least one vocal characteristic is described.

For Case 2 1100, the electronic device 200 may obtain a second audio signal [symbol] from the second user voice input [symbol] In addition, because the second syllable [symbol] differs in pitch and loudness from other syllables, the electronic device 200 may identify [symbol] as a vocal characteristic of the second audio signal.

In addition, the electronic device 200 may obtain a score for at least one voice change included in the second audio signal by comparing first pronunciation information with second pronunciation information. For example, based on the first pronunciation information and the second pronunciation information, the electronic device 200 may obtain [symbol] [symbol] [symbol] and [symbol] as 0, 0.6, 0, and 0, respectively. Because [symbol] is greater than the first threshold of 0.5, the electronic device 200 may identify the second syllable [symbol] as at least one corrected syllable included in the second audio signal. However, because [symbol] is less than the second threshold of 0.7, the electronic device 200 may identify at least one corrected audio signal for the first audio signal [symbol] by using the NE dictionary.

The electronic device 200 according to an embodiment of the disclosure may identify at least one misrecognized syllable included in the first audio signal, by comparing the at least one corrected syllable [symbol] included in the second audio signal with at least one syllable of the first audio signal [symbol] For example, 1) [symbol] is similar to [symbol] in that they have initial consonants, medial vowels, and final consonants, 2) [symbol] and [symbol] have the same initial consonant and medial vowel, and 3) [symbol] and [symbol] may be the same as each other in that they are the second syllables. Accordingly, the electronic device 200 may identify at least one misrecognized syllable [symbol] based on the at least one corrected syllable [symbol] and the first audio signal [symbol] In addition, the electronic device 200 may identify, as the at least one misrecognized word, [symbol] including the at least one misrecognized syllable

[symbol]

The electronic device 200 according to an embodiment of the disclosure may identify, from among the at least one word included in the NE dictionary, at least one word similar to the at least one corrected word [symbol] For example, the electronic device 200 may obtain, from among the at least one word included in the NE dictionary, at least one word [symbol] the similarity of which to the at least one corrected word [symbol] is greater than or equal to the preset threshold.

The electronic device 200 according to an embodiment of the disclosure may identify at least one corrected audio signal for the first audio signal by correcting the at least one misrecognized word [symbol] to the at least one corrected word or the at least one word. In Case 2 1100, because the at least one corrected word and the at least one word are the same as [symbol] the at least one corrected audio signal may be identified as

[symbol]

For Case 3 1130, the electronic device 200 may obtain a second audio signal [symbol] from the second user voice input [symbol] Accordingly, the electronic device 200 may misrecognize not only the first audio signal but also the second audio signal.

The electronic device 200 may determine that the pitch and loudness of the second syllable [symbol] are the same as those of other syllables, and that the interval between the first syllable and the second syllable is less than a preset interval. Accordingly, the electronic device 200 may determine that the second audio signal [symbol] does not have a vocal characteristic.

In this case, the electronic device 200 may more accurately identify a corrected audio signal for the first audio signal by using the NE dictionary. For example, the electronic device 200 may obtain, from among the at least one word included in the NE dictionary, at least one word [symbol] similar to the second audio signal. [symbol] In this case, the electronic device 200 may obtain [symbol] by searching the NE dictionary even though both the first and second utterances have been misrecognized. Here, [symbol] is the name of a content creator whose number of subscribers has increased rapidly in a short time period, and even in a case in which [symbol] has not been updated to the speech recognition engine, the electronic device 200 may obtain the at least one word [symbol] by searching the ranking NE dictionary of the background app.

FIG. 12 is a flowchart illustrating in detail a method of, in a case in which a first audio signal and a second audio signal are not similar to each other, identifying at least one corrected audio signal for the first audio signal according to whether a voice pattern of the second audio signal corresponds to at least one preset voice pattern.

In operation S1210, in a case in which the first audio signal and the second audio signal are not similar to each other, the electronic device 200 may identify, based on a natural language processing model, that the voice pattern of the second audio signal corresponds to the at least one preset voice pattern.

The electronic device 200 according to an embodiment of the disclosure may determine the context of the second audio signal based on the natural language processing model, and identify, based on the identified context of the second audio signal, that the voice pattern of the second audio signal corresponds to the at least one preset voice pattern. In the disclosure, a preset voice pattern may refer to a set of voice patterns of voices uttered with an intention of correcting a misrecognized audio signal.

A complete voice pattern according to an embodiment of the disclosure may refer to a voice pattern including both 1) a post-correction word and a post-correction syllable and 2) a pre-correction word and a pre-correction syllable, among the preset voice patterns. In a case in which an audio signal recognized from an utterance for a misrecognized audio signal is a complete voice pattern, the electronic device may clearly correct the misrecognized audio signal based on 1) the post-correction word and the post-correction syllable included in the complete voice pattern and 2) the pre-correction word (or the misrecognized word) and the pre-correction syllable (or the misrecognized syllable) included in the complete voice pattern, and thus identify an accurate corrected audio signal for the first audio signal.

In operation S1220, the electronic device 200 may obtain at least one of at least one corrected word or at least one corrected syllable by using a natural language processing model, based on the voice pattern of the second audio signal.

As the electronic device 200 according to an embodiment of the disclosure has identified that the voice pattern of the second audio signal corresponds to the at least one preset voice pattern, the electronic device 200 may obtain at least one of at least one corrected word or at least one corrected syllable, based on the voice pattern of the second audio signal. For example, in a case in which the voice pattern of the second audio signal is “Not A but B”, a word and a syllable corresponding to ‘B’ in “Not A and B” may correspond to at least one corrected syllable and at least one corrected word in the disclosure, respectively. Thus, the electronic device 200 may obtain at least one of at least one corrected word or at least one corrected syllable by identifying the voice pattern of the second audio signal or the context of the second audio signal by using the natural language processing model.

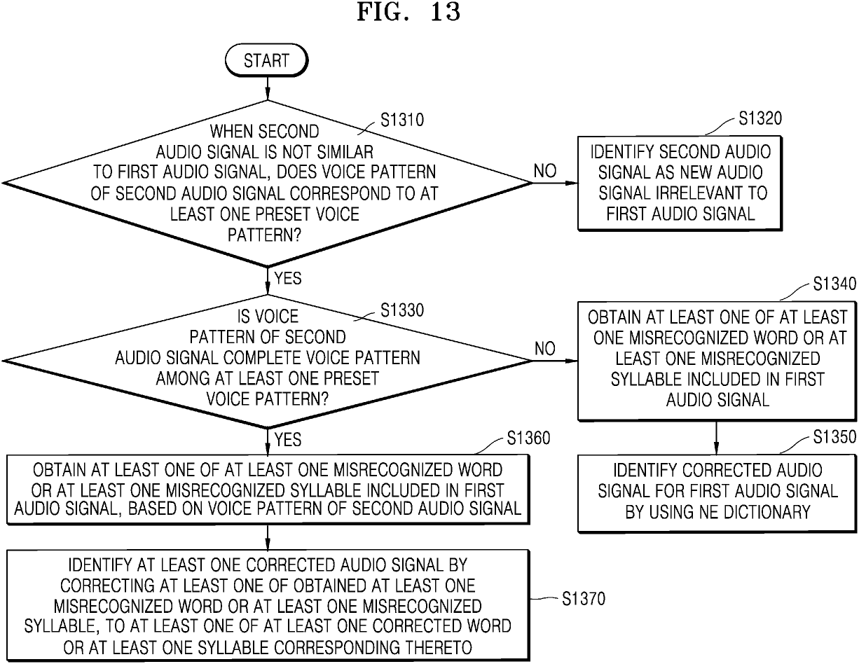

FIG. 13 is a flowchart illustrating in detail a method of identifying at least one corrected audio signal for a first audio signal, according to whether a voice pattern of a second audio signal corresponds to at least one preset voice pattern.

In operation S1310, in a case in which the second audio signal is not similar to the first audio signal, the electronic device 200 may identify whether the voice pattern of the second audio signal corresponds to the at least one preset voice pattern.

The electronic device 200 according to an embodiment of the disclosure may determine whether the second audio signal is similar to the first audio signal. For example, the electronic device 200 may obtain, based on an acoustic model that is trained based on acoustic information, probability information about the degree to which the first audio signal and the second audio signal match each other, and identify the similarity between the first audio signal and the second audio signal according to the obtained probability information. In a case in which the similarity between the first audio signal and the second audio signal is less than the preset threshold, the electronic device 200 may identify that the second audio signal is not similar to the first audio signal.

In a case in which the second audio signal is not similar to the first audio signal, the electronic device 200 according to an embodiment of the disclosure may identify whether the voice pattern of the second audio signal corresponds to the at least one preset voice pattern. The user may input, to the electronic device 200, the second user voice input that is not similar to the first user voice input with an intention of correcting the first audio signal. Accordingly, the electronic device 200 may identify whether the voice pattern of the second audio signal corresponds to the at least one preset voice pattern by using the natural language processing model. For example, in a case in which the second audio signal is “It’s [symbol] the electronic device 200 may determine, by using a natural language processing model, that the second audio signal is to emphasize [symbol] that is commonly included in [symbol] Accordingly, the electronic device 200 may determine, by using the natural language processing model, that the voice pattern of the second audio signal corresponds to “It’s B in A” among the at least one preset voice pattern.

In operation S1320, the electronic device 200 may identify the second audio signal as a new audio signal irrelevant to the first audio signal.

In a case in which the voice pattern of the second audio signal does not correspond to the at least one preset voice pattern, the electronic device 200 according to an embodiment of the disclosure may identify the second audio signal as a new audio signal that is not for correcting the first audio signal. Accordingly, the electronic device 200 may output, to the user, a search result for the new audio signal by executing a speech recognition function on the new audio signal.

In operation S1330, the electronic device 200 may identify whether the voice pattern of the second audio signal is a complete voice pattern among the at least one preset voice pattern.

In a case in which a method of correcting the first audio signal may be clearly specified based only on the second audio signal, the electronic device 200 according to an embodiment of the disclosure may identify a corrected audio signal for the first audio signal without performing a separate operation using the NE dictionary. As an embodiment of the disclosure of clearly specifying a method of correcting the first audio signal, the electronic device 200 may determine whether to perform an operation of searching the NE dictionary, according to whether the voice pattern of the second audio signal is a complete voice pattern among the at least one preset voice pattern.

A complete voice pattern according to an embodiment of the disclosure may refer to a voice pattern including both 1) a post-correction word and a post-correction syllable and 2) a pre-correction word and a pre-correction syllable, among the preset voice patterns. Accordingly, in a case in which the electronic device 200 determines that a user voice input corresponds to a complete voice pattern, the electronic device 200 may accurately identify at least one corrected audio signal by recognizing the context. For example, complete voice patterns may include voice patterns such as “Not A but B” or “B is correct, A is not”. In a case in which the voice pattern of the second audio signal is “Not A but B”, the electronic device 200 may analyze the context of the second audio signal by using the natural language processing model, and thus determine that ‘A’ in “Not A but B” corresponds to a pre-correction word and a pre-correction syllable, and ‘B’ in “Not A but B” corresponds to a post-correction word and a post-correction syllable.

In a case in which the voice pattern of the second audio signal according to an embodiment of the disclosure is a complete voice pattern, the electronic device 200 may clearly determine a pre-correction word or a pre-correction syllable to be corrected, by using the second audio signal and the first audio signal. Accordingly, in a case in which the voice pattern of the second audio signal is a complete voice pattern, the electronic device 200 may identify at least one corrected audio signal suitable for the first audio signal without searching the NE dictionary.

In operation S1340, in a case in which the voice pattern of the second audio signal is not a complete voice pattern among the at least one preset voice pattern, the electronic device 200 may obtain at least one of at least one misrecognized word or at least one misrecognized syllable included in the first audio signal, based on at least one of at least one corrected word or at least one corrected syllable.

The electronic device 200 may obtain at least one corrected word or at least one corrected syllable from the second audio signal by using the natural language processing model. In detail, the electronic device 200 may identify at least one corrected word or at least one corrected syllable considering the context of the second audio signal by recognizing the voice pattern of the second audio signal by using the natural language processing model. The at least one corrected word or the at least one corrected syllable may be a part of at least one word or at least one syllable included in the second audio signal.

In a case in which the voice pattern of the second audio signal according to an embodiment of the disclosure is not included in complete voice patterns among the at least one preset voice pattern, at least one misrecognized word and at least one misrecognized syllable to be corrected may not be directly included in the second audio signal. Accordingly, the electronic device 200 may identify at least one misrecognized word and at least one misrecognized syllable to be corrected, by using at least one of the at least one corrected word or the at least one corrected syllable included in the second audio signal. For example, the electronic device 200 may identify, from among the at least one word and the at least one syllable included in the first audio signal, at least one misrecognized word and at least one misrecognized syllable that are similar to the at least one corrected word and the at least one corrected syllable, respectively. Here, the at least one misrecognized word may be a word including the at least one misrecognized syllable, but is not limited thereto. For example, there may be no misrecognized syllables for homonyms, and the at least one misrecognized word may refer to a word including at least one misrecognized letter.

In operation S1350, the electronic device 200 may identify a corrected audio signal for the first audio signal by using the NE dictionary.

The electronic device 200 according to an embodiment of the disclosure may obtain, from among the at least one word included in the NE dictionary, at least one word, the similarity of which to the at least one corrected word is greater than or equal to a preset threshold. The electronic device 200 may obtain at least one word, the similarity of which to the at least one corrected word is greater than or equal to the preset threshold, by searching the ranking NE dictionary of the background app for the at least one corrected word. Accordingly, even in a case in which the voice pattern of the second audio signal does not correspond to a complete audio signal, the electronic device 200 may more accurately predict a corrected audio signal for the first audio signal based on at least one word obtained by the searching.

The electronic device 200 according to an embodiment of the disclosure may identify at least one corrected audio signal for the first audio signal by correcting, to at least one word, at least one misrecognized word included in the first audio signal predicted as having been misrecognized. In addition, the electronic device 200 may identify at least one corrected audio signal for the first audio signal by correcting, to at least a corrected audio signal, at least one misrecognized word included in the first audio signal predicted as having been misrecognized.

Accordingly, the electronic device 200 may obtain at least one word by using the ranking NE dictionary of the background app, even in a case in which the second user voice input is misrecognized because the update of an engine for recognizing an audio signal is delayed. The electronic device 200 may identify at least one corrected audio signal suitable for the first audio signal by correcting, to the obtained at least one word, the at least one misrecognized word included in the first audio signal predicted as having been misrecognized.

In operation S1360, the electronic device 200 may obtain at least one of at least one misrecognized word or at least one misrecognized syllable included in the first audio signal, based on the voice pattern of the second audio signal that is identified as a complete voice pattern.

The electronic device 200 may obtain at least one corrected word or at least one corrected syllable from the second audio signal by using the natural language processing model. In detail, the electronic device 200 may identify at least one corrected word or at least one corrected syllable considering the context of the second audio signal by recognizing the voice pattern of the second audio signal by using the natural language processing model. The at least one corrected word or the at least one corrected syllable may be a part of at least one word or at least one syllable included in the second audio signal.

The electronic device 200 according to an embodiment of the disclosure may obtain at least one word and at least one syllable included in a part to be corrected, by using the natural language processing model and the voice pattern of the second audio signal. For example, in a case in which the second audio signal is “Not [symbol] but [symbol] the electronic device 200 may identify the context of the second audio signal and thus identify [symbol] as the at least one word and the at least one syllable included in the part to be corrected.

The electronic device 200 according to an embodiment of the disclosure may obtain at least one of at least one misrecognized word or at least one misrecognized syllable included in the first audio signal, based on the voice pattern of the second audio signal that is identified as a complete voice pattern. In detail, the electronic device 200 may obtain at least one of the at least one misrecognized word or the at least one misrecognized syllable included in the first audio signal, by using the at least one word and the at least one syllable included in the part of the second audio signal to be corrected. In a case in which the voice pattern of the second audio signal is a complete voice pattern, a word or a syllable to be corrected may be identified from the second audio signal. Therefore, by using the identified word or syllable to be corrected, the electronic device 200 may easily obtain at least one of the at least one misrecognized word or at least one misrecognized syllable included in the first audio signal.

In operation S1370, the electronic device 200 may identify at least one corrected audio signal by correcting at least one of the obtained at least one misrecognized word or at least one misrecognized syllable, to at least one of at least one corrected word or at least one syllable corresponding thereto.

The electronic device 200 according to an embodiment of the disclosure may obtain at least one of at least one misrecognized word or at least one misrecognized syllable included in the first audio signal, and correct the at least one of the obtained at least one misrecognized word or at least one misrecognized syllable to at least one of the at least one corrected word or the at least one syllable corresponding thereto. Accordingly, the electronic device 200 may identify at least one corrected audio signal suitable for the first audio signal by correcting the misrecognized word or syllable to the corrected word or syllable without a separate operation of searching the NE dictionary.

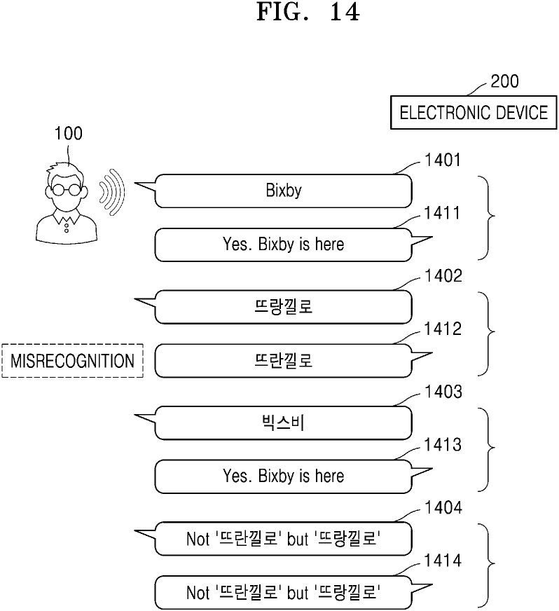

FIG. 14 is a diagram illustrating a detailed method of identifying at least one corrected audio signal for a first audio signal according to whether a voice pattern of a second audio signal corresponds to at least one preset voice pattern, according to an embodiment of the disclosure.

Referring to FIG. 14, in response to reception of “Bixby” 1401 from the user 100, the electronic device 200 may output an audio signal “Yes. Bixby is here” 1411 to request the user to speak a command-related utterance. Accordingly, the user 100 may input a first user voice input [symbol] 1402 to the electronic device 200, and the electronic device 200 may misrecognize the first user voice input [symbol] 1402 as [symbol] 1412, which is a first audio signal.

The user 100 may input a second user voice input to the electronic device 200 to correct the first audio signal [symbol] 1412. Before inputting the second user voice input to the electronic device 200, the user 100 may speak “Bixby” 1403 and then receive an audio signal “Yes. Bixby is here” 1413 from the electronic device.

In order to make it clear that the utterance of the user 100 is [symbol] rather than [symbol] misrecognized from the first audio signal, the user 100 may input an utterance with a context for comparing the word to be corrected with a post-correction word. For example, the user 100 may input a second user voice input “Not [symbol] but [symbol] 1404 to the electronic device 200.

The electronic device 200 according to an embodiment of the disclosure may receive the second user voice input “Not [symbol] 1404, and obtain a second audio signal “Not [symbol] 1414, through the speech recognition engine. Based on whether the second audio signal “Not [symbol] 1414 corresponds to the at least one preset voice pattern, the electronic device 200 may identify whether the second audio signal is for correcting the first audio signal

[symbol]

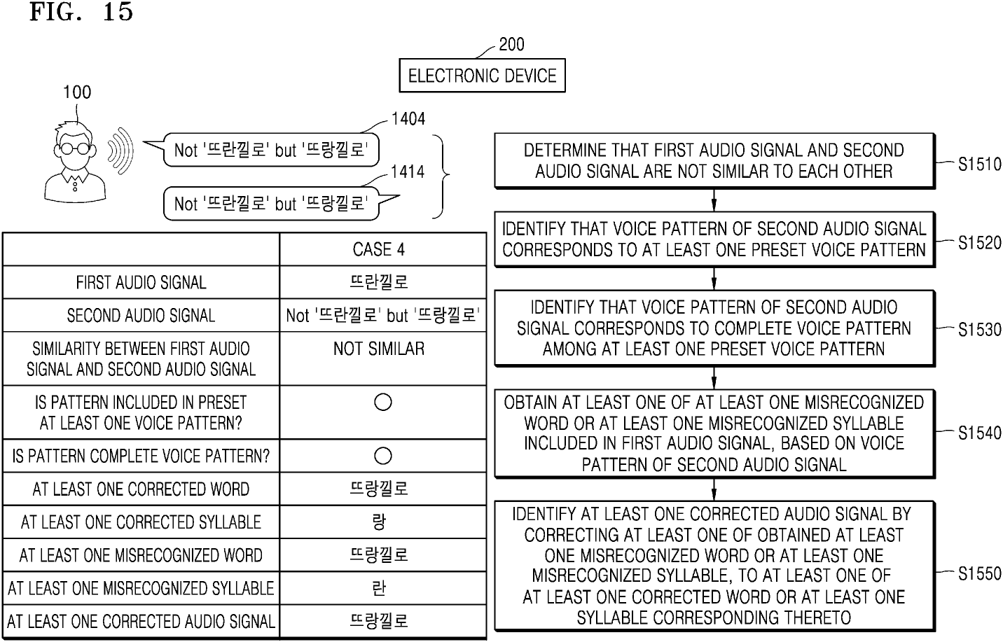

FIG. 15 is a diagram illustrating a detailed method, which is subsequent to the method of FIG. 14, of identifying at least one corrected audio signal for a first audio signal according to whether a voice pattern of a second audio signal corresponds to at least one preset voice pattern, according to an embodiment of the disclosure. Referring to FIG. 14, based on whether the second audio signal “Not [symbol] but [symbol] 1414 corresponds to the at least one preset voice pattern, the electronic device 200 may identify whether the second audio signal is for correcting the first audio signal [symbol] The electronic device 200 may identify at least one corrected audio signal for the first audio signal according to a result of the determining of whether the second audio signal is for correcting the first audio signal

[symbol]

In operation S1510, the electronic device 200 may determine that the first audio signal and the second audio signal are not similar to each other.

The electronic device 200 according to an embodiment of the disclosure may determine whether the first audio signal [symbol] and the second audio signal “Not [symbol] are similar to each other. For example, because the numbers of syllables and the numbers of words of the first audio signal [symbol] and the second audio signal “Not [symbol] are different from each other, the electronic device 200 may determine that the first audio signal and the second audio signal are not similar to each other. In detail, the electronic device 200 may determine, based on an acoustic model that is trained based on acoustic information, the similarity between [symbol] and [symbol] but [symbol] according to probability information about the degree to which [symbol] match each other. In a case in which the similarity between [symbol] is less than a preset threshold, the electronic device 200 may determine that the second audio signal is not similar to the first audio signal.

In operation S1520, the electronic device 200 may identify that the voice pattern of the second audio signal corresponds to the at least one preset voice pattern.

The user may input, to the electronic device 200, the second user voice input that is not similar to the first user voice input with an intention of correcting the first audio signal. The electronic device 200 may identify whether the voice pattern of the second audio signal corresponds to the at least one preset voice pattern by using the natural language processing model.

For example, referring to FIG. 15, in a case in which the second audio signal is “Not [symbol] the electronic device 200 may identify that the voice pattern of the second audio signal corresponds to “Not A but B” among the at least one preset voice pattern, by using the natural language processing model. The voice pattern “Not A but B” may be a voice pattern used to correct a misrecognized word or misrecognized syllable ‘A’ in “Not A but B” to a corrected word or corrected syllable ‘B’ in “Not A but B”. Accordingly, the electronic device 200 may determine, by using the natural language processing model, that “Not [symbol] is a pattern for correcting the misrecognized word [symbol] to the corrected word

[symbol]

However, the disclosure is not limited thereto, and the electronic device 200 according to an embodiment of the disclosure may determine that the voice pattern of the second audio signal does not correspond to the at least one preset voice pattern. In this case, the electronic device 200 may identify the second audio signal as a new audio signal irrelevant to the first audio signal (operation S1320). However, hereinafter, a case in which the voice pattern of the second audio signal corresponds to the at least one preset voice pattern will be described in detail according to a particular embodiment of the disclosure corresponding to FIG. 15.

In operation S1530, the electronic device 200 may identify that the voice pattern of the second audio signal corresponds to a complete voice pattern among the at least one preset voice pattern.

A complete voice pattern according to an embodiment of the disclosure may refer to a voice pattern including both 1) a post-correction word and a post-correction syllable and 2) a pre-correction word and a pre-correction syllable, among the preset voice patterns. Complete voice patterns may include voice patterns such as “Not A but B” or “B is correct, A is not”.

For example, referring to FIGS. 14 and 15, in a case in which the second audio signal is “Not [symbol] the electronic device 200 may identify that the voice pattern “Not [symbol] of the second audio signal corresponds to “Not A but B” among complete voice patterns, by using the natural language processing model. Accordingly, the electronic device 200 may perform the following operation without a separate operation of searching the NE dictionary.

However, the disclosure is not limited thereto, and the electronic device 200 according to an embodiment of the disclosure may determine that the voice pattern of the second audio signal does not correspond to a complete voice pattern among the at least one preset voice pattern. In this case, the electronic device 200 may identify a corrected audio signal for the first audio signal by using the NE dictionary (operation S1350). However, hereinafter, a case in which the voice pattern of the second audio signal corresponds to a complete voice pattern among the at least one preset voice pattern will be described in detail according to a particular embodiment of the disclosure corresponding to FIG. 15.

In operation S1540, the electronic device 200 may obtain at least one of at least one misrecognized word or at least one misrecognized syllable included in the first audio signal, based on the voice pattern of the second audio signal.

The electronic device 200 according to an embodiment of the disclosure may obtain at least one word and at least one syllable included in a part to be corrected, by using the natural language processing model and the voice pattern of the second audio signal. For example, in a case in which the second audio signal is “Not [symbol] but [symbol] the electronic device 200 may identify the context of the second audio signal and thus identify [symbol] as the at least one word and the at least one syllable included in the part to be corrected.

The electronic device 200 according to an embodiment of the disclosure may obtain at least one of the at least one misrecognized word or the at least one misrecognized syllable included in the first audio signal, by using [symbol] that is identified as the at least one word and the at least one syllable included in the part to be corrected. In detail, the electronic device 200 may obtain, as at least one of the at least one misrecognized word or the at least one misrecognized syllable, a word or syllable similar to [symbol] that is identified as a target to be corrected from among at least one word and at least one syllable included in the first audio signal. For example, because [symbol] included in the first audio signal is the same as [symbol] (included in the second audio signal) that is identified as the target to be corrected, the electronic device 200 may identify [symbol] included in the first audio signal as a misrecognized word.

In operation S1550, the electronic device 200 may identify at least one corrected audio signal by correcting at least one of the obtained at least one misrecognized word or at least one misrecognized syllable, to at least one of at least one corrected word or at least one syllable corresponding thereto.

The electronic device 200 according to an embodiment of the disclosure may obtain at least one of at least one misrecognized word or at least one misrecognized syllable included in the first audio signal, and correct the at least one of the obtained at least one misrecognized word or at least one misrecognized syllable to at least one of the at least one corrected word or the at least one syllable corresponding thereto. For example, referring to FIG. 15, the electronic device 200 may obtain the misrecognized word [symbol] included in the first audio signal, and correct the misrecognized word [symbol] to at least one corresponding corrected word [symbol] Accordingly, the electronic device 200 may identify at least one corrected audio signal [symbol] suitable for the first audio signal by correcting the misrecognized word [symbol] to the at least one corrected word [symbol] without a separate operation of searching the NE dictionary.

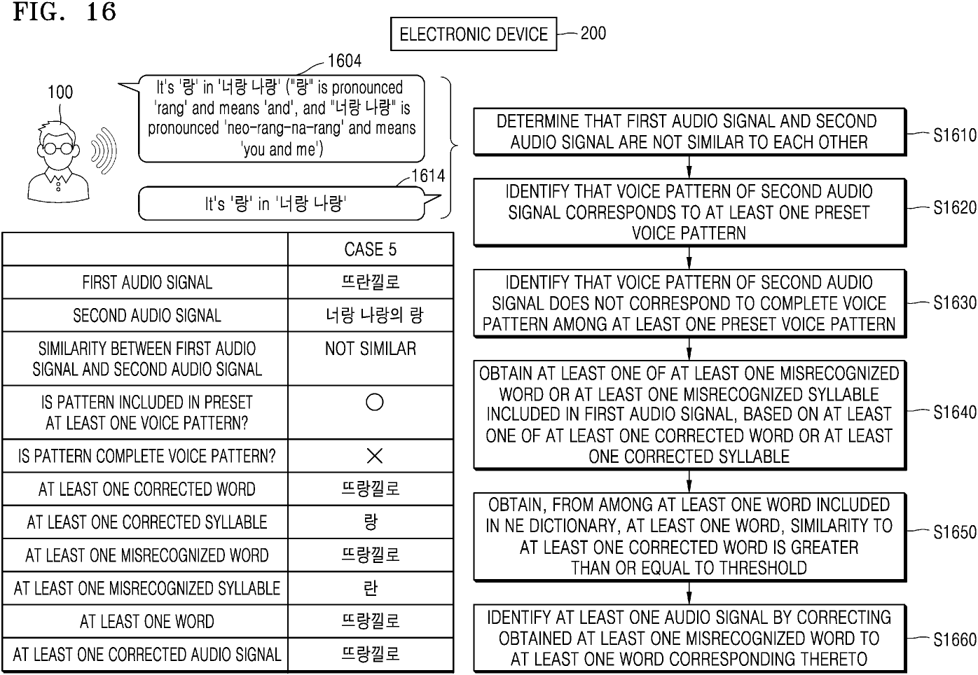

FIG. 16 is a diagram illustrating a detailed method of identifying at least one corrected audio signal for a first audio signal according to whether a voice pattern of a second audio signal corresponds to at least one preset voice pattern, according to an embodiment of the disclosure.

Referring to FIG. 16, the electronic device 200 may obtain a second audio signal “It’s [symbol] 1614 from a second user voice input “It’s [symbol] 1604 of the user 100. Based on whether the second audio signal “It’s [symbol] 1614 corresponds to the at least one preset voice pattern, the electronic device 200 may identify whether the second audio signal is for correcting the first audio signal [symbol] The electronic device 200 may identify at least one corrected audio signal for the first audio signal according to a result of the determining of whether the second audio signal is for correcting the first audio signal

[symbol]

In operation S1610, the electronic device 200 may determine that the first audio signal and the second audio signal are not similar to each other.

The electronic device 200 according to an embodiment of the disclosure may determine whether the first audio signal [symbol] and the second audio signal “It’s [symbol] in [symbol] are similar to each other. Because the numbers of syllables and the numbers of words of the first audio signal [symbol] and the second audio signal “It’s [symbol] in [symbol] are different from each other, the electronic device 200 may determine that the first audio signal and the second audio signal are not similar to each other. In detail, the electronic device 200 may determine, based on an acoustic model that is trained based on acoustic information, the similarity between [symbol] and “It′s [symbol] [symbol] according to probability information about the degree to which [symbol] and “It′s [symbol] match each other. In a case in which the similarity between [symbol] and “It’s [symbol] is less than the preset threshold, the electronic device 200 may determine that the second audio signal “It’s [symbol] is not similar to the first audio signal

[symbol]

In operation S1620, the electronic device 200 may identify that the voice pattern of the second audio signal corresponds to the at least one preset voice pattern.

The user may input the second user voice input that is not similar to the first user voice input, to the electronic device 200 with an intention of correcting the first audio signal, and the electronic device 200 may identify, by using the natural language processing model, whether the voice pattern of the second audio signal corresponds to the at least one preset voice pattern.

For example, referring to FIG. 16, in a case in which the second audio signal is “Its [symbol] the electronic device 200 may identify that the voice pattern of the second audio signal corresponds to “It’s B in A” among the at least one preset voice pattern, by using the natural language processing model.

The voice pattern “It’s B in A” may be a voice pattern for emphasizing ‘B’ included in ‘A’. For example, “It’s [symbol] may be an audio signal used to emphasize [symbol] that is commonly included in [symbol] Accordingly, the electronic device 200 may determine, by using the natural language processing model, that the second audio signal “It’s [symbol] is a context for emphasizing [symbol] that is commonly included in

[symbol]

However, the disclosure is not limited thereto, and the electronic device 200 according to an embodiment of the disclosure may determine that the voice pattern of the second audio signal does not correspond to the at least one preset voice pattern. In this case, the electronic device 200 may identify the second audio signal as a new audio signal irrelevant to the first audio signal (operation S1320). However, hereinafter, a case in which the voice pattern of the second audio signal corresponds to the at least one preset voice pattern will be described in detail according to a particular embodiment of the disclosure corresponding to FIG. 16.

In operation S1630, the electronic device 200 may identify that the voice pattern of the second audio signal does not correspond to a complete voice pattern among the at least one preset voice pattern.

Complete voice patterns according to an embodiment of the disclosure may include voice patterns such as “Not A but B” or “B is correct, A is not”. However, referring to FIG. 16, in a case in which the second audio signal is “It’s [symbol] the electronic device 200 may identify that the voice pattern of the second audio signal does not correspond to a complete voice pattern, by using the natural language processing model. Accordingly, the second audio signal may be an audio signal that 1) includes a post-correction word and a post-correction syllable, but 2) does not include a pre-correction word and a pre-correction syllable. Accordingly, the electronic device 200 may use the NE dictionary to more accurately identify at least one corrected audio signal.

However, the disclosure is not limited thereto, and the electronic device 200 according to an embodiment of the disclosure may determine that the voice pattern of the second audio signal corresponds to a complete voice pattern among the at least one preset voice pattern. In this case, the electronic device 200 may clearly identify a corrected audio signal for the first audio signal without using the NE dictionary (operations S1360 and S1370). However, hereinafter, a case in which the voice pattern of the second audio signal does not correspond to a complete voice pattern among the at least one preset voice pattern will be described in detail according to a particular embodiment of the disclosure corresponding to FIG. 16.

In operation S1640, based on at least one of the at least one corrected word or the at least one corrected syllable, the electronic device 200 may obtain at least one of at least one misrecognized word or at least one misrecognized syllable included in the first audio signal.

The electronic device 200 may obtain at least one of at least one corrected word or at least one corrected syllable from the second audio signal by using the natural language processing model. In detail, the electronic device 200 may identify the at least one of the at least one corrected word or the at least one corrected syllable through the context of the second audio signal by recognizing the voice pattern of the second audio signal by using the natural language processing model. For example, referring to FIG. 16, in a case in which the second audio signal is “It’s [symbol] the electronic device 200 may obtain, as a corrected syllable, [symbol] that is a syllable commonly included in [symbol] and [symbol] by using the natural language processing model.

Because the electronic device 200 has identified, by using the natural language processing model, that the voice pattern of the second audio signal does not correspond to a complete voice pattern, the electronic device 200 needs to obtain at least one of at least one misrecognized word or at least one misrecognized syllable to be corrected.

The electronic device 200 according to an embodiment of the disclosure may obtain at least one corrected word or at least one corrected syllable included in the second audio signal. As an embodiment of obtaining at least one of at least one misrecognized word or at least one misrecognized syllable to be corrected, the electronic device 200 according to an embodiment of the disclosure may obtain at least one of at least one misrecognized word or at least one misrecognized syllable included in the first audio signal, based on at least one of at least one corrected word or at least one corrected syllable included in the second audio signal. For example, the electronic device 200 may determine that [symbol] in the first audio signal [symbol] and the obtained corrected syllable [symbol] are similar to each other in pronunciation, and identify [symbol] in the first audio signal [symbol] as a misrecognized syllable. In detail, considering that 1) [symbol] are syllables consisting of an initial consonant, a medial vowel, and a final consonant, and 2) [symbol] have the same initial consonant and medial vowel, the electronic device 200 may predict that [symbol] has been misrecognized as [symbol] and thus the first audio signal [symbol] has been obtained. In addition, [symbol] including the misrecognized syllable [symbol] may be a misrecognized word.

In operations S1650 and S1660, the electronic device 200 may obtain, from among the at least one word included in the NE dictionary, at least one word, the similarity to the at least one corrected word is greater than or equal to a threshold, and identify at least one audio signal by correcting the obtained at least one misrecognized word to the at least one word corresponding thereto.

The electronic device 200 according to an embodiment of the disclosure may identify at least one corrected audio signal, based on at least one of the at least one corrected word or the at least one corrected syllable, and at least one of the at least one misrecognized word or the at least one misrecognized syllable included in the first audio signal. For example, the electronic device 200 may identify at least one corrected audio signal for the first audio signal [symbol] based on the misrecognized syllable [symbol] and the corrected syllable [symbol] In detail, the electronic device 200 may identify at least one corrected word [symbol] by replacing the misrecognized syllable [symbol] included in the first audio signal [symbol] with the corrected syllable

[symbol]

Referring to FIG. 16, because the second audio signal “It’s [symbol] does not directly specify at least one word or at least one syllable to be corrected, in order to improve the accuracy of speech recognition, the electronic device 200 may obtain at least one word similar to the at least one corrected word from the NE dictionary.

The electronic device 200 according to an embodiment of the disclosure may obtain, from among the at least one word included in the NE dictionary, at least one word, the similarity of which to the at least one corrected word [symbol] is greater than or equal to the threshold. Referring to FIG. 16, the electronic device 200 may obtain at least one word [symbol] by searching the NE dictionary. In addition, the electronic device 200 may identify the corrected audio signal [symbol] for the first audio signal by correcting the misrecognized word [symbol] to the at least one word

[symbol]

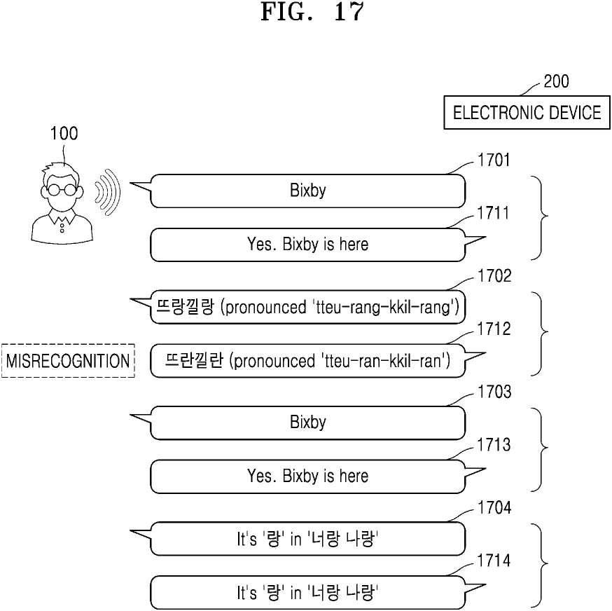

FIG. 17 is a diagram illustrating a detailed method of identifying at least one corrected audio signal for a first audio signal according to whether a voice pattern of a second audio signal corresponds to at least one preset voice pattern, according to an embodiment of the disclosure.

Referring to FIG. 17, in response to reception of “Bixby” 1701 from the user 100, the electronic device 200 may output an audio signal “Yes. Bixby is here” 1711 to request the user to speak a command-related utterance. Accordingly, the user 100 may input a first user voice input [symbol] 1702 (pronounced ‘tteu-rang-kkil-rang’) to the electronic device 200, and the electronic device 200 may misrecognize the first user voice input [symbol] 1702 as [symbol] 1712 (pronounced ‘tteu-ran-kkil-ran’), which is a first audio signal.

The user 100 may input a second user voice input to the electronic device 200 to correct the first audio signal [symbol] 1712. Before inputting the second user voice input to the electronic device 200, the user 100 may speak “Bixby” 1703 and then receive an audio signal “Yes. Bixby is here” 1713 from the electronic device.

The user 100 may speak an utterance to clarify that [symbol] that is misrecognized from the first audio signal is incorrect and a corrected syllable [symbol] is correct. For example, the user 100 may input a second user voice input “It’s [symbol] 1704 to the electronic device 200. Here, “It’s [symbol] may be a voice input for emphasizing [symbol] that is commonly included in

[symbol]

The electronic device 200 according to an embodiment of the disclosure may receive the second user voice input “It’s [symbol] 1704, and obtain a second audio signal “It’s [symbol] 1714, through the speech recognition engine. Based on whether the voice pattern of the second audio signal “It’s [symbol] 1714 corresponds to the at least one preset voice pattern, the electronic device 200 may identify whether the second audio signal is for correcting the first audio signal

[symbol]

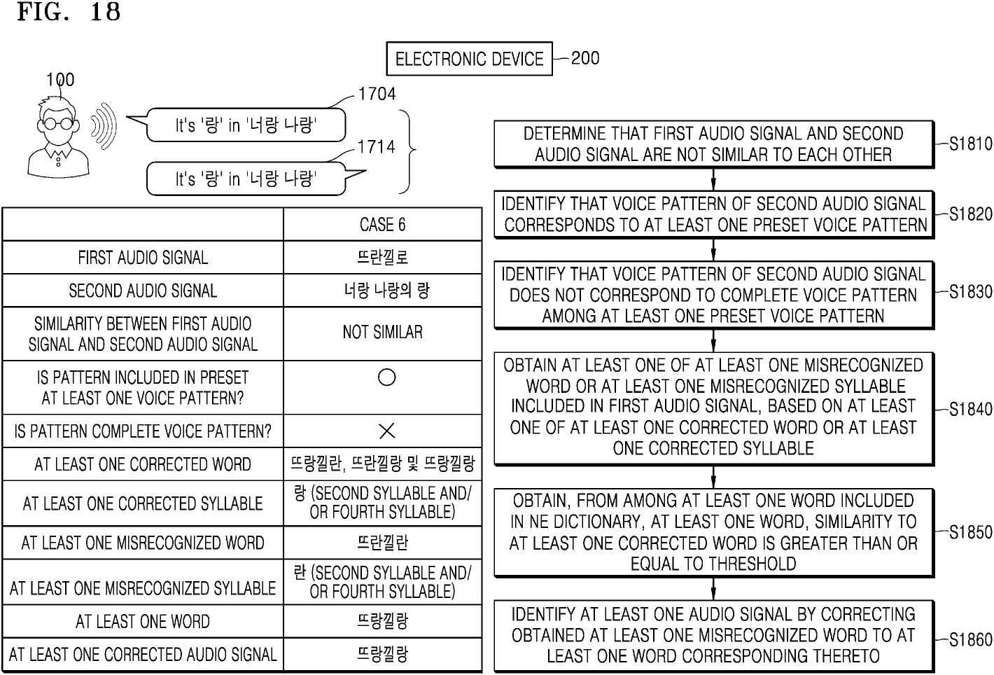

FIG. 18 is a diagram illustrating a detailed method, which is subsequent to the method of FIG. 17, of identifying at least one corrected audio signal for a first audio signal according to whether a voice pattern of a second audio signal corresponds to at least one preset voice pattern, according to an embodiment of the disclosure.

Referring to FIG. 18, the electronic device 200 may obtain the second audio signal “It’s [symbol] 1714 from the second user voice input “It’s [symbol] 1704 of the user 100. Based on whether the second audio signal “It’s [symbol] 1714 corresponds to the at least one preset voice pattern, the electronic device 200 may identify whether the second audio signal is for correcting the first audio signal

[symbol]

In operation S1810, the electronic device 200 may determine that the first audio signal and the second audio signal are not similar to each other.

The electronic device 200 according to an embodiment of the disclosure may determine whether the first audio signal [symbol] 1712 and the second audio signal “It′s [symbol] 1714 are similar to each other. Because the numbers of syllables and the numbers of words of the first audio signal [symbol] 1712 and the second audio signal “It’s [symbol] 1714 are different from each other, the electronic device 200 may determine that the first audio signal and the second audio signal are not similar to each other. In detail, the electronic device 200 may determine, based on an acoustic model that is trained based on acoustic information, the similarity between [symbol] and “It’s [symbol] according to probability information about the degree to which [symbol] match each other. In a case in which the similarity between [symbol] and “It’s [symbol] is less than the preset threshold, the electronic device 200 may determine that the second audio signal “It’s [symbol] 1714 is not similar to the first audio signal [symbol] 1712.

In operation S1620, the electronic device 200 may identify that the voice pattern of the second audio signal corresponds to the at least one preset voice pattern.

The user 100 may input the second user voice input that is not similar to the first user voice input, to the electronic device 200 with an intention of correcting the first audio signal, and the electronic device 200 may identify, by using the natural language processing model, whether the voice pattern of the second audio signal corresponds to the at least one preset voice pattern.

For example, referring to FIG. 18, in a case in which the second audio signal is “It’s [symbol] 1714, the electronic device 200 may identify that the voice pattern of the second audio signal corresponds to “It’s B in A” among the at least one preset voice pattern, by using the natural language processing model.

The voice pattern “It’s B in A” may be a voice pattern for emphasizing ‘B’ included in ‘A’. For example, “It’s [symbol] may be an audio signal used to emphasize [symbol] that is commonly included in [symbol] Accordingly, the electronic device 200 may determine, by using the natural language processing model, that “It′s [symbol] [symbol] is a context for emphasizing [symbol] that is commonly included in

[symbol]

However, the disclosure is not limited thereto, and the electronic device 200 according to an embodiment of the disclosure may determine that the voice pattern of the second audio signal does not correspond to the at least one preset voice pattern. In this case, the electronic device 200 may identify the second audio signal as a new audio signal irrelevant to the first audio signal (operation S1320). However, hereinafter, a case in which the voice pattern of the second audio signal corresponds to the at least one preset voice pattern will be described in detail according to a particular embodiment of the disclosure corresponding to FIG. 18.

In operation S1830, the electronic device 200 may identify that the voice pattern of the second audio signal does not correspond to a complete voice pattern among the at least one preset voice pattern.

Complete voice patterns according to an embodiment of the disclosure may include voice patterns such as “Not A but B” or “B is correct, A is not”. However, referring to FIG. 18, in a case in which the second audio signal is “It’s [symbol] 1714, the electronic device 200 may identify that the voice pattern of the second audio signal does not correspond to a complete voice pattern, by using the natural language processing model. Accordingly, the second audio signal 1) may include a post-correction word and a post-correction syllable, but 2) may not include a pre-correction word and a pre-correction syllable.

However, the disclosure is not limited thereto, and the electronic device 200 according to an embodiment of the disclosure may determine that the voice pattern of the second audio signal corresponds to a complete voice pattern among the at least one preset voice pattern. In this case, the electronic device 200 may clearly identify a corrected audio signal for the first audio signal without using the NE dictionary (operations S1360 and S1370). However, hereinafter, a case in which the voice pattern of the second audio signal does not correspond to a complete voice pattern among the at least one preset voice pattern will be described in detail according to a particular embodiment of the disclosure corresponding to FIG. 18.

In operation S1840, based on at least one of the at least one corrected word or the at least one corrected syllable, the electronic device 200 may obtain at least one of at least one misrecognized word or at least one misrecognized syllable included in the first audio signal.

The electronic device 200 may obtain at least one corrected word or at least one corrected syllable from the second audio signal by using the natural language processing model. In detail, the electronic device 200 may identify at least one corrected word or at least one corrected syllable considering the context of the second audio signal by recognizing the voice pattern of the second audio signal by using the natural language processing model. For example, referring to FIG. 18, in a case in which the second audio signal is “It’s [symbol] 1714, the electronic device 200 may consider the context of the second audio signal and obtain, as a corrected syllable, [symbol] that is a syllable commonly included in [symbol] by using the natural language processing model.

Because the electronic device 200 has identified, by using the natural language processing model, that the voice pattern of the second audio signal does not correspond to a complete voice pattern, the electronic device 200 needs to identify at least one of at least one misrecognized word or at least one misrecognized syllable to be corrected.

The electronic device 200 according to an embodiment of the disclosure may obtain at least one corrected word or at least one corrected syllable included in the second audio signal. As an embodiment of obtaining at least one of at least one misrecognized word or at least one misrecognized syllable, the electronic device 200 according to an embodiment of the disclosure may obtain at least one of at least one misrecognized word or at least one misrecognized syllable included in the first audio signal, based on at least one of at least one corrected word or at least one corrected syllable included in the second audio signal. For example, because [symbol] obtained from the first audio signal [symbol] 1712 and the corrected syllable [symbol] are similar to each other in pronunciation, the electronic device 200 may identify [symbol] in the first audio signal [symbol] 1712 as a misrecognized syllable. In addition, [symbol] including the misrecognized syllable [symbol] may be a misrecognized word.

However, the first audio signal [symbol] 1712 may be an audio signal including the identified misrecognized syllable [symbol] as both the second and fourth syllables thereof. Thus, the electronic device 200 may not clearly identify which of the second syllable [symbol] and the fourth syllable [symbol] included in [symbol] 1712 has been misrecognized.

In operations S1850 and S1860, the electronic device 200 may obtain, from among the at least one word included in the NE dictionary, at least one word, the similarity to the at least one corrected word is greater than or equal to a threshold, and identify at least one audio signal by correcting the obtained at least one misrecognized word to the at least one word corresponding thereto.

The electronic device 200 according to an embodiment of the disclosure may identify at least one corrected audio signal, based on at least one of the at least one corrected word or the at least one corrected syllable, and at least one of the at least one misrecognized word or the at least one misrecognized syllable included in the first audio signal.

For example, the electronic device 200 may identify at least one corrected audio signal for the first audio signal [symbol] based on the misrecognized syllable [symbol] and the corrected syllable [symbol] In detail, the electronic device 200 may predict at least one corrected word [symbol] (pronounced ‘tteu-rang-kkil-ran’), [symbol] (pronounced ‘tteu-ran-kkil-rang’), and [symbol] by replacing the misrecognized syllable [symbol] included in the first audio signal [symbol] with the corrected syllable [symbol] In detail, 1) in a case in which the second syllable [symbol] is misrecognized, the at least one corrected word may be [symbol] 2) in a case in which the fourth syllable [symbol] of [symbol] is misrecognized, the at least one corrected word may be [symbol] and 3) in a case in which the second and fourth syllables [symbol] are misrecognized, the at least one corrected word may be

[symbol]

Accordingly, because a plurality of corrected words are obtained in the case of the embodiment of FIG. 18, the electronic device 200 may obtain at least one word by using the NE dictionary, and thus more accurately identify at least one corrected audio signal for the first audio signal. In addition, because the second audio signal “It’s [symbol] in [symbol] does not directly specify at least one word or at least one syllable to be corrected, in order to improve the accuracy of speech recognition, the electronic device 200 may obtain at least one word similar to the at least one corrected word from the NE dictionary.

The electronic device 200 according to an embodiment of the disclosure may obtain, from among the at least one word included in the NE dictionary, at least one word, the similarity of which to the at least one corrected word [symbol] and [symbol] is greater than or equal to the threshold. Referring to FIG. 18, the electronic device 200 may obtain at least one word [symbol] In addition, the electronic device 200 may identify the corrected audio signal [symbol] for the first audio signal by correcting the misrecognized word [symbol] to the at least one word [symbol] Thus, even in a case in which there are a plurality of corrected words corresponding to the misrecognized word [symbol] the electronic device 200 may identify a more accurate corrected audio signal [symbol] for the first audio signal, based on the obtained at least one word

[symbol]

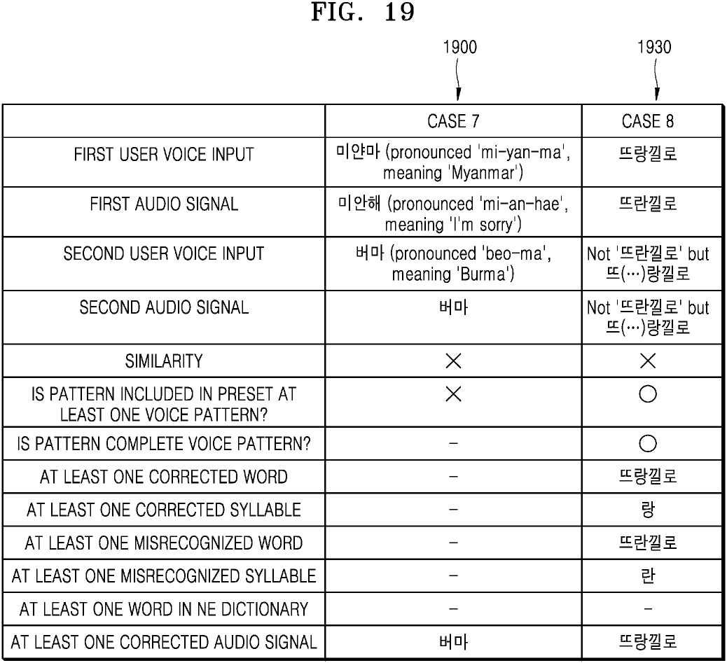

FIG. 19 is a diagram illustrating a detailed embodiment of the disclosure of identifying at least one corrected audio signal for a first audio signal according to whether a voice pattern of a second audio signal corresponds to at least one preset voice pattern, according to an embodiment of the disclosure.

Referring to FIG. 19, Case 7 1900 represents a case in which the first user voice input is [symbol] (pronounced ‘mi-yan-ma’, meaning ‘Myanmar’), and the second user voice input is [symbol] (pronounced ‘beo-ma’, meaning ‘Burma’), and Case 8 1930 represent a case in which the first user voice input is [symbol] and the second user voice input is “Not

[symbol]

Case 7 1900 describes a case in which the first user voice input is [symbol] and the second user voice input is

[symbol]

The electronic device 200 according to an embodiment of the disclosure may receive the first user voice input [symbol] from the user, and recognize the first audio signal as [symbol] (pronounced ‘mi-an-hae’, meaning ‘I’m sorry’) through the voice recognition engine. Accordingly, the electronic device 200 may misrecognize the first user voice input [symbol] as the first audio signal

[symbol]

Accordingly, the user may input, to the electronic device 200, the second user voice input [symbol] that differs in pronunciation from the first user voice input [symbol] but has the same meaning as that of [symbol] The electronic device 200 may identify the second audio signal as [symbol] through the speech recognition engine.

Because the first audio signal [symbol] and the second audio signal [symbol] are not similar to each other, the electronic device 200 according to an embodiment of the disclosure may identify whether the second audio signal is included in preset voice patterns. Referring to Case 7 1900 of FIG. 19, the second audio signal [symbol] may not be included in the preset voice patterns. Accordingly, the electronic device 200 may identify the second audio signal [symbol] as a new audio signal that is not an audio signal for correcting the first audio signal [symbol] The user 100 may be provided with search information for [symbol] and thus provided with information similar to search information for [symbol] which is used for a similar meaning to that of

[symbol]

Case 8 1930 describes a case in which the first user voice input is [symbol] and the second user voice input is “Not

[symbol]

The electronic device 200 according to an embodiment of the disclosure may receive the first user voice input [symbol] from the user, and recognize the first audio signal as [symbol] through the voice recognition engine. Thus, misrecognition may occur with respect to the utterance [symbol] of the user. In detail, the electronic device 200 may misrecognize the second syllable

[symbol]

Accordingly, in order to correct the misrecognized first audio signal [symbol] the user may input “Not [symbol] to the electronic device 200. The electronic device 200 may identify the second audio signal as “Not [symbol] but [symbol] through the speech recognition engine. The electronic device 200 may identify that “Not ‘ [symbol] is included in the at least one preset voice pattern, and in particular, corresponds to “Not A but B” among the complete voice patterns of the specification.

The electronic device 200 according to an embodiment of the disclosure may consider the context of the second audio signal “Not [symbol] by using the natural language processing model, and thus identify [symbol] as a corrected word.

In addition, in order for the electronic device 200 to identify a corrected syllable from the second audio signal in Case 8 1930, obtaining a score for a voice change in at least one syllable included in the second audio signal by comparing first pronunciation information with second pronunciation information, and identifying, as at least one corrected syllable, at least one syllable, the score of which is greater than or equal to a preset threshold, which are described above with reference to FIGS. 8 to 11, may be equally applied. For example, referring to operations S1030 and S1040, the electronic device 200 may identify, as a corrected syllable for the second audio signal “Not [symbol] the syllable [symbol] the score of which for a voice change is greater than the preset threshold, from among the syllables included in

[symbol]

The electronic device 200 according to an embodiment of the disclosure may consider the context of the second audio signal “Not [symbol] by using the natural language processing model, and thus identify [symbol] as a word to be corrected. Because [symbol] to be corrected is similar to the first audio signal [symbol] the electronic device 200 may identify, as a misrecognized word, [symbol] included in the first audio signal. In addition, the electronic device 200 may identify, as a misrecognized syllable, [symbol] included in the misrecognized word [symbol] by comparing the misrecognized word [symbol] with the corrected syllable [symbol] In addition, because “Not [symbol] is a complete voice pattern, and 1) a word or syllable to be corrected and 2) a post-correction word or a post-correction syllable is clearly specified in the second audio signal, at least one corrected audio signal for the first audio signal may be identified without using the NE dictionary, but the disclosure is not limited thereto.

The electronic device 200 according to an embodiment of the disclosure may identify a corrected audio signal [symbol] for the first audio signal [symbol] by correcting the misrecognized syllable word [symbol] and the misrecognized syllable [symbol] to the corrected word [symbol] and the corrected syllable [symbol] respectively.

FIG. 20 is a flowchart illustrating in detail a method of identifying at least one corrected audio signal by obtaining, from among at least one word included in an NE dictionary, at least one word similar to at least one corrected word.

In a case in which a newly input text other than those stored in a speech recognition DB (or a speech recognition engine) is input as a voice, the electronic device may misrecognize the voice of the user. For example, a text related to a buzzword that has recently increased in popularity may not have been updated to the speech recognition DB yet, and thus, it may be difficult for the electronic device to accurately recognize the voice of the user. In this case, the electronic device may obtain at least one word from an NE dictionary of a background app, and thus identify at least one corrected audio signal suitable for a misrecognized first audio signal.

The electronic device 200 according to an embodiment of the disclosure may obtain at least one word from the NE dictionary and use it to identify at least one corrected audio signal. In a case in which it is determined that a second audio signal 1) includes only a post-correction word or syllable, and 2) does not explicitly include pre-correction word or syllable, the electronic device 200 may identify at least one corrected audio signal more accurately by using the NE dictionary, but the disclosure is not limited thereto.

In operation S2010, based on at least one of at least one corrected word or at least one corrected syllable, the electronic device 200 may obtain at least one misrecognized word included in the first audio signal.

Because the word or syllable to be corrected is not clearly recognized from the second audio signal, the electronic device 200 according to an embodiment of the disclosure may obtain at least one misrecognized word included in the first audio signal by using at least one of at least one corrected word or at least one corrected syllable. For example, referring to FIG. 16, the electronic device 200 may identify [symbol] as a corrected syllable, and identify, as a misrecognized syllable, [symbol] that is similar to [symbol] from among the syllables included in the first audio signal [symbol] In addition, the at least one misrecognized word may refer to a word including at least one misrecognized syllable. For example, referring to FIG. 16, [symbol] including the misrecognized syllable [symbol] may correspond to a misrecognized word. Accordingly, based on at least one of at least one corrected word or at least one corrected syllable, the electronic device 200 may obtain at least one misrecognized word included in the first audio signal. The obtained at least one misrecognized word may refer to a word to be corrected.

In operation S2020, the electronic device 200 may obtain, from among at least one word included in the NE dictionary, at least one word, the similarity of which to the at least one corrected word is greater than or equal to a preset threshold.

The electronic device 200 according to an embodiment of the disclosure may obtain, from among the at least one word included in the NE dictionary, at least one word, the similarity of which to the at least one corrected word is greater than or equal to a preset threshold. In particular, in a case in which an utterance of the user includes a word that has recently increased in popularity or the name of a person, the electronic device 200 may obtain at least one appropriate word by searching a ranking NE dictionary of a background app. For example, referring to FIG. 18, the electronic device 200 may obtain, from among the at least one word included in the NE dictionary, at least one word, the similarity of which to at least one corrected word [symbol] is greater than or equal to a preset threshold. Accordingly, the electronic device 200 may obtain at least one word [symbol] obtained from the NE dictionary, from among the at least one corrected word

[symbol]

In operation S2030, the electronic device 200 may identify at least one corrected audio signal by correcting the obtained at least one misrecognized word, to at least one of the at least one word corresponding thereto or the at least one corrected word.

The electronic device 200 according to an embodiment of the disclosure may identify at least one corrected audio signal by correcting the obtained at least one misrecognized word to the at least one word corresponding thereto. For example, referring to FIG. 18, the electronic device 200 may identify the corrected audio signal [symbol] for the first audio signal [symbol] by correcting the misrecognized word [symbol] to the word [symbol] obtained by searching.

Thus, even in a case in which a plurality of corrected words correspond to a misrecognized word, the electronic device 200 may identify the accurate corrected audio signal [symbol] for the first audio signal, based on the obtained at least one word. In addition, even in a case in which a word that has not been updated to the speech recognition engine is input, the electronic device 200 may identify at least one corrected audio signal that meets the intention of the user, by searching the ranking NE dictionary of the background app.

The method according to an embodiment of the disclosure may be provided in the form of a non-transitory machine-readable storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the non-transitory storage medium may include a buffer in which data is temporarily stored.

According to an embodiment of the disclosure, the method according to various embodiments of the disclosure may be included in a computer program product and provided. The computer program products may be traded as commodities between sellers and buyers. The computer program product may be distributed in the form of a machine-readable storage medium (e.g., a disc read-only memory (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer’s server, an application store’s server, or a memory of a relay server.

While the embodiments of the disclosure have been particularly shown and described, it will be understood by one of ordinary skill in the art that various changes in form and details may be made therein without departing from the spirit and scope of the disclosure. Hence, it should be understood that the embodiments of the disclosure described above are not limiting of the scope of the disclosure. For example, each element described in a single type may be executed in a distributed manner, and elements described distributed may also be executed in an integrated form.

The scope of the disclosure is defined by the claims below rather than the above detailed description, and should be construed that all modifications or modified forms derived from the meaning and scope of the claims and their equivalents are included in the scope of the disclosure.

What is claimed is:

1. A method, performed by an electronic device, of processing a voice input of a user, the method comprising:
obtaining a first audio signal from a first user voice input of the user;
obtaining a second audio signal from a second user voice input of the user that is obtained subsequent to the first audio signal;
identifying whether the second audio signal is an audio signal for correcting the obtained first audio signal;
in response to the identifying that the obtained second audio signal is the audio signal for correcting the obtained first audio signal, obtaining, from the obtained second audio signal, at least one of one or more corrected words or one or more corrected syllables;
based on the obtained at least one of the one or more corrected words or the one or more corrected syllables, identifying at least one corrected audio signal for the obtained first audio signal; and
processing the identified at least one corrected audio signal.

2. The method of claim 1,
wherein the identifying of whether the obtained second audio signal is the audio signal for correcting the first audio signal comprises, based on a similarity between the obtained first audio signal and the obtained second audio signal, identifying at least one of whether the obtained second audio signal has at least one vocal characteristic or whether a voice pattern of the obtained second audio signal corresponds to at least one preset voice pattern.

3. The method of claim 1, wherein the identifying of the at least one corrected audio signal comprises:
based on the obtained at least one of the one or more corrected words and the one or more corrected syllables, obtaining at least one misrecognized word included in the obtained first audio signal;
obtaining, from among at least one word included in a named entity (NE) dictionary, at least one word, a similarity of which to the one or more corrected words is greater than or equal to a preset first threshold; and
identifying the at least one corrected audio signal by correcting the obtained at least one misrecognized word, to at least one of the at least one word corresponding to the obtained at least one misrecognized word, or the at least one corrected word.

4. The method of claim 2, wherein the identifying of the at least one of whether the obtained second audio signal has the at least one vocal characteristic, and whether the voice pattern of the obtained second audio signal corresponds to the at least one preset voice pattern comprises, when the obtained similarity is greater than or equal to a preset second threshold, identifying whether the obtained second audio signal has the at least one vocal characteristic, and when the obtained similarity is less than the preset second threshold, identifying whether the voice pattern of the obtained second audio signal corresponds to the at least one preset voice pattern.

5. The method of claim 4, wherein the identifying of whether the obtained second audio signal has the at least one vocal characteristic comprises:
obtaining second pronunciation information for each of at least one syllable included in the obtained second audio signal; and
based on the second pronunciation information, identifying whether the at least one syllable included in the obtained second audio signal has the at least one vocal characteristic.

6. The method of claim 5, wherein the identifying of whether the obtained second audio signal has the at least one vocal characteristic comprises:
when the at least one syllable included in the obtained second audio signal has the at least one vocal characteristic, obtaining first pronunciation information for each of at least one syllable included in the obtained first audio signal;
obtaining a score for a voice change in the at least one syllable included in the obtained second audio signal, by comparing the obtained first pronunciation information with the obtained second pronunciation information; and
identifying at least one syllable, the obtained score of which is greater than or equal to a preset third threshold, and identifying, as the one or more corrected syllables and the one or more corrected words, the identified at least one syllable and at least one word corresponding to the identified at least one syllable, respectively.

7. The method of claim 6, wherein the first pronunciation information comprises at least one of accent information, amplitude information, or duration information for each of the at least one syllable included in the obtained first audio signal, and
the second pronunciation information comprises at least one of accent information, amplitude information, or duration information for each of the at least one syllable included in the obtained second audio signal.

8. The method of claim 4, wherein the identifying of whether the voice pattern of the obtained second audio signal corresponds to the at least one preset voice pattern comprises, based on a natural language processing (NLP) model, identifying that the voice pattern of the obtained second audio signal corresponds to the at least one preset voice pattern, and
the obtaining of the at least one of the one or more corrected words or the one or more corrected syllables comprises, based on the voice pattern of the second audio signal, obtaining the at least one of the one or more corrected words or the one or more corrected syllables, by using the NLP model.

9. The method of claim 8, wherein the identifying of the at least one corrected audio signal comprises:
identifying, by using the NLP model, whether the voice pattern of the obtained second audio signal is a complete voice pattern among the at least one preset voice pattern;
based on the voice pattern of the obtained second audio signal being identified as the complete voice pattern, obtaining at least one of one or more misrecognized words and one or more misrecognized syllables included in the obtained first audio signal; and
identifying the at least one corrected audio signal by correcting the obtained at least one of the one or more misrecognized words or the one or more misrecognized syllables, to the at least one of the one or more corrected words or the one or more corrected syllables corresponding thereto, and
the complete voice pattern is a voice pattern including at least one of one or more misrecognized words or one or more misrecognized syllables of an audio signal, and at least one of one or more corrected words or one or more corrected syllables, among the at least one preset voice pattern.

10. The method of claim 8, wherein the identifying of the at least one corrected audio signal comprises:
based on the at least one of the one or more corrected words or the one or more corrected syllables, obtaining at least one of one or more misrecognized words or one or more misrecognized syllables included in the obtained first audio signal; and
based on the at least one of the one or more corrected words or the one or more corrected syllables, and the at least one of the one or more misrecognized words or the one or more misrecognized syllables included in the obtained first audio signal, identifying the at least one corrected audio signal.

11. The method of claim 1, wherein the processing of the at least one corrected audio signal comprises receiving, from the user, a response signal related to misrecognition, as search information for the at least one corrected audio signal is output to the user, and requesting the user to perform reutterance according to the response signal.

12. An electronic device for processing a voice input of a user, the electronic device comprising:
a memory storing one or more instructions; and
at least one processor configured to
execute the one or more instructions to obtain a first audio signal from a first user voice input of the user,
obtain a second audio signal from a second user voice input of the user that is obtained subsequent to the first audio signal,
identify whether the second audio signal is an audio signal for correcting the first audio signal;
in response to the identifying that the obtained second audio signal is the audio signal for correcting the first audio signal, obtain, from the obtained second audio signal, at least one of one or more corrected words and one or more corrected syllables,
based on the obtained at least one of the one or more corrected words or the one or more corrected syllables, identify at least one corrected audio signal for the obtained first audio signal, and
process the at least one corrected audio signal.

13. The electronic device of claim 12, wherein the at least one processor is further configured to execute the one or more instructions to, based on a similarity between the obtained first audio signal and the obtained second audio signal, identify at least one of whether the second audio signal has at least one vocal characteristic or whether a voice pattern of the obtained second audio signal corresponds to at least one preset voice pattern.

14. The electronic device of claim 12, wherein the at least one processor is further configured to execute the one or more instructions to,
based on the obtained at least one of the one or more corrected words or the one or more corrected syllables,
obtain at least one misrecognized word included in the first audio signal,
obtain, from among at least one word included in a named entity (NE) dictionary, at least one word, a similarity of which to the one or more corrected words is greater than or equal to a preset first threshold, and
identify the at least one corrected audio signal by correcting the obtained at least one misrecognized word, to at least one of the at least one word corresponding to the obtained at least one misrecognized word, or the at least one corrected word.

15. The electronic device of claim 12, wherein the at least one processor is further configured to execute the one or more instructions to, when the similarity is greater than or equal to a preset second threshold, identify whether the obtained second audio signal has the at least one vocal characteristic, and when the similarity is less than the preset second threshold, identify whether the voice pattern of the obtained second audio signal corresponds to the at least one preset voice pattern.

16. The electronic device of claim 12, wherein the at least one processor is further configured to execute the one or more instructions to obtain second pronunciation information for each of at least one syllable included in the obtained second audio signal, and based on the second pronunciation information, identify whether the at least one syllable included in the obtained second audio signal has the at least one vocal characteristic.

17. The electronic device of claim 12, wherein the at least one processor is further configured to execute the one or more instructions to, when the at least one syllable included in the obtained second audio signal has the at least one vocal characteristic, obtain first pronunciation information for each of at least one syllable included in the obtained first audio signal, obtain a score for a voice change in the at least one syllable included in the obtained second audio signal by comparing the obtained first pronunciation information with the obtained second pronunciation information, and identify at least one syllable, the obtained score of which is greater than or equal to a preset third threshold, and identify, as the one or more corrected syllables and the one or more corrected words, the identified at least one syllable and at least one word corresponding to the identified at least one syllable, respectively.

18. The electronic device of claim 12, wherein the at least one processor is further configured to execute the one or more instructions to, based on a natural language processing (NLP) model stored in the memory, identify whether the voice pattern of the obtained second audio signal corresponds to the at least one preset voice pattern, and based on the voice pattern of the obtained second audio signal, obtain the at least one of the one or more corrected words or the one or more corrected syllables, by using the NLP model.

19. The electronic device of claim 12, wherein the at least one processor is further configured to execute the one or more instructions to, based on the at least one of the one or more corrected words or the one or more corrected syllables, obtain at least one of one or more misrecognized words or one or more misrecognized syllables included in the obtained first audio signal, and based on the at least one of the one or more corrected words or the one or more corrected syllables, and the at least one of the one or more misrecognized words or the one or more misrecognized syllables included in the obtained first audio signal, identify the at least one corrected audio signal.

20. A non-transitory computer-readable recording medium having recorded thereon instructions for causing a processor of an electronic device to perform the method of claim 1.
